(19) United States
(12) Patent Application Publication
(10) Pub. No.: US 2008/0193800 A1
(43) Pub. Date: Aug. 14, 2008

(54) Magnetic Recording Medium, Production Method Thereof, and Magnetic Recording and Reproducing Apparatus

(75) Inventors: Hiroshi Osawa, Chiba-shi (JP); Kenji Shimizu, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku (JP)

(21) Appl. No.: 11/884,652

(22) PCT Filed: Oct. 27, 2005
(86) PCT No.: PCT/JP2005/020159

§ 371 Date: Aug. 30, 2007

Related U.S. Application Data
(60) Provisional application No. 60/658,145, filed on Mar. 4, 2005.

(30) Foreign Application Priority Data
Feb. 25, 2005 (JP) 2005-050878
Mar. 22, 2005 (JP) 2005-082053
Jun. 13, 2005 (JP) 2005-172199

(51) Int. Cl. G11B 5/66

(52) U.S. Cl. 428/831.1; 428/831

(57) ABSTRACT

In a magnetic recording medium which is able to cope with a higher recording density, there is provided a magnetic recording medium which has a higher coercive force and a lower noise, a production method thereof, and a magnetic recording and reproducing apparatus. The magnetic recording medium is characterized in that at least a nonmagnetic undercoat layer, a nonmagnetic intermediate layer, a magnetic layer, and a protective layer are laminated in this order on a nonmagnetic substrate, and at least one of the layers of the nonmagnetic undercoat layer is constituted by a WV type multicomponent body-centered cubic crystal alloy.

Priority is claimed to Japanese Application No. 2005-050878, filed Feb. 25, 2005, Japanese Application No. 2005-082053, filed Mar. 22, 2005, and Japanese Application No. 2005-172199, filed Jun. 13, 2005, which are incorporated herein by reference. This application also claims the benefit pursuant to 35 U.S.C. §119(e) (1) of U.S. Provisional Application No. 60/658,145, filed on Mar. 4, 2005.

### TECHNICAL FIELD

The present invention relates to a magnetic recording medium used in hard disk drive and the like, a production method of the magnetic recording medium, and a magnetic recording and reproducing apparatus.

### BACKGROUND ART

Hard disk drive (HDD) which are one type of magnetic recording and reproducing apparatus, have currently reached a recording density of 100 Gbits/in², and it is said that the improvement in recording density will continue in the future at an annual rate of 30%. Consequently, the development of magnetic recording heads, and the development of magnetic recording mediums suitable for high recording density is being advanced. It is required for magnetic recording mediums used for hard disk drive to increase the recording density, to improve coercive force, and to reduce a medium noise. For magnetic recording mediums used for hard disk drive, a structure where metal films are laminated on a substrate for a magnetic recording medium by the sputtering method is mainstream. For a substrate used for a magnetic recording medium, aluminum substrates and glass substrates are widely used. An aluminum substrate is a mirror polished Al—Mg alloy with a Ni—P type alloy film formed on the substrate to a thickness of approximately 10 μm by electroless deposition, with a surface which is further mirror finished. For the two types of glass substrates, there are amorphous glass and crystallized glass. For either glass substrate, one which is mirror finished is used.

Currently, in magnetic recording mediums generally used in hard disk drive, a nonmagnetic undercoat layer (Cr, Cr type alloy or the like, Ni—Al type alloy), a nonmagnetic intermediate layer (Co—Cr, Co—Cr—Ta type alloy or the like), a magnetic layer (Co—Cr—Pt—Ta, Co—Cr—Pt—B type alloy or the like), and a protective layer (carbon or the like) are sequentially deposited on a nonmagnetic substrate, whereupon a lubricating layer comprising liquid lubricant is formed.

A Co—Cr—Pt—Ta alloy, Co—Cr—Pt—B alloy, and the like are used as the magnetic layer are alloys, which comprises Co as the principal component. The Co alloy takes a hexagonal close-packed structure (hcp structure) which has an axis of easy magnetization in its C-axis. For a recording method of the magnetic recording medium, there are in-plane recording and perpendicular recording, and a Co alloy is generally used for the magnetic film. In the case of in-plane recording, the C-axis of the Co alloy is oriented parallel to the nonmagnetic substrate, and in the case of a perpendicular medium, the C-axis of the Co alloy is oriented perpendicular to the nonmagnetic substrate. Accordingly, in the case of in-plane recording, it is preferable that the Co alloy is oriented in the (10·0) plane or the (11·0) plane.

To increase the recording density of magnetic recording mediums, it is necessary to decrease medium noise. Non-Patent Document 1 below describes a theoretical formula which indicates that it is effective to make the average crystalline particle diameter and the grain size distribution of the Co alloy smaller in order to decrease the medium noise. Non-Patent Document 2 below describes that by making the average crystalline particle diameter and the grain size distribution of the Co alloy smaller, the medium noise is decreased, and that a magnetic recording medium suitable for high recording density was provided. In such a manner, it is important for decreasing medium noise to reduce the average crystalline particle diameter and the grain size distribution of the Co alloy smaller. Since the Co alloy can be epitaxially grown on the Cr alloy, it can be easily considered that formation of Co alloy film contributes to reduce the average crystalline particle diameter and the grain size distribution of the Co alloy smaller.

It has been reported that addition of a variety of elements to Cr improves its properties. Patent Document 1 below describes that addition of Ti to Cr is effective. Patent Document 2 below describes that addition of V to Cr is effective. Patent Document 3 below reports that addition of Mo and W to Cr is effective. Patent Document 4 and Patent Document 5 below report that it is effective to construct an undercoat layer by two layers which have Cr as their principal component but a different additional element. In Patent Document 6 below, it is described that addition of oxygen and nitrogen to the nonmagnetic undercoat layer which has Cr as its principal component, is effective.

[Patent Document 1] Japanese Unexamined Patent Application, First Publication No. Sho 63-197018

[Patent Document 2] U.S. Pat. No. 4,652,499

[Patent Document 3] Japanese Unexamined Patent Application, First Publication No. Sho 63-187416

[Patent Document 4] Japanese Unexamined Patent Application, First Publication No. Hei 7-73427

[Patent Document 5] Japanese Unexamined Patent Application, First Publication No. 2000-322732

[Patent Document 6] Japanese Unexamined Patent Application, First Publication No. Hei 11-283235

[Patent Document 7] European Patent No. 0704839

[Patent Document 8] Japanese Unexamined Patent Application, First Publication No. 2003-123243

[Non-Patent Document 1] J. Appl. Phys. vol. 87, pp. 5365-5370

[Non-Patent Document 2] J. Appl. Phys. vol. 87, pp. 5407-5409

### DISCLOSURE OF INVENTION

As mentioned above, a Cr alloy is mainly used as the nonmagnetic undercoat layer. As a method of decreasing the medium noise by improving the nonmagnetic undercoat layer, micronization of the average crystalline particle diameter and improvement of orientation of the Cr alloy, and lattice matching with the Co alloy have been used. Since the Cr alloy used for the nonmagnetic undercoat layer has Cr as its principal component, the characteristics thereof mainly originate from the inherent characteristics of Cr. As a result, the scope for design of the nonmagnetic undercoat layer of the magnetic recording medium becomes consequently narrowed.

A number of attempts using a Cr alloy in the nonmagnetic undercoat layer have been proposed. In Patent Document 7, it has been proposed that the noise can be improved by using an alloy which has a B2 structure (AlNi, AlCo, AlFe, and the like) as the nonmagnetic undercoat layer, thus making the grain size in the magnetic film smaller. However, since it is difficult to make the coercive force large by use of an Al—Ni alloy, and it is difficult to make rectangularity ratio of the coercive force large by use of an Al—Co alloy, the reproduction output becomes smaller, as a result, leaving problems to realize a high recording density.

In Patent Document 8, it has been proposed that the noise can be improved by depositing Mo, W, or MoTi alloy, or WTi alloy on an oxide orientation control film such as MgO. However, elemental substance of Mo or W, or alloys such as MoTi and WTi have a limit to the decrease in noise, and are unable to cope with a recording density exceeding 50 Gbits/in².

The present invention has been carried out to solve the above-mentioned problems with an object of providing a magnetic recording medium which is able to cope with a higher recording density, a magnetic recording medium which has a higher coercive force and a lower noise, a production method thereof, and a magnetic recording and reproduction apparatus.

In order to solve the above problems, the present inventor, as a result of earnest investigation and effort, has completed the present invention by identifying that the characteristics of the magnetic recording and reproducing apparatus can be improved by utilizing a WV type alloy, or a MoV type alloy as the nonmagnetic undercoat layer. That is to say, the present invention relates to the following.

(1) A magnetic recording medium comprising at least a nonmagnetic undercoat layer, a nonmagnetic intermediate layer, a magnetic layer, and a protective layer, laminated in the ascending order on a nonmagnetic substrate, wherein at least one layer of said nonmagnetic undercoat layer is constituted by a multicomponent body-centered cubic crystal alloy, which comprises at least one element selected from the A group consisting of Cr and V, at least one element selected from the B group consisting of Mo and W, and at least one element selected from the C group consisting of Nb, Ta, and Ti.

(2) A magnetic recording medium having at least a nonmagnetic undercoat layer, a stabilizing layer, a nonmagnetic intermediate layer, a nonmagnetic coupling layer, a magnetic layer, and a protective layer, laminated in the ascending order on a nonmagnetic substrate, and said stabilizing layer is antiferromagnetically coupled to said magnetic layer, wherein at least one layer of said nonmagnetic undercoat layer is constituted by a multicomponent body-centered cubic crystal alloy comprising at least one element selected from the following A group consisting of Cr and V, at least one element selected from the B group consisting of Mo and W, and at least one element selected from the C group consisting of Nb, Ta, and Ti.

(3) The magnetic recording medium according to either one of claim 1 and claim 2, wherein in the multicomponent body-centered cubic crystal alloy used in said nonmagnetic undercoat layer, the element selected from the A group has a total content of 10 to 60 at %, the element selected from the B group has a total content of 10 to 80 at %, and the element selected from the C group has a total content of 10 to 60 at %.

(4) The magnetic recording medium according to any one of claim 1 through claim 3, wherein the multicomponent body-centered cubic crystal alloy used in said nonmagnetic undercoat layer has a body-centered cubic structure, and the lattice constant is from 3.05 to 3.20 Å.

(5) The magnetic recording medium according to any one of claim 1 through claim 4, wherein said nonmagnetic intermediate layer comprises at least one elemental metal or alloy selected from the group consisting of CoCr alloys, CoCrPt alloys, Ru, a Ru alloys, Re, and Re alloys.

(6) The magnetic recording medium according to any one of claim 1 through claim 4, wherein said nonmagnetic coupling layer comprises at least one elemental metal or alloy selected from the group consisting of Ru, Rh, Ir, Cr, Re, Ru alloys, Rh alloys, Ir alloys, Cr alloys, and Re alloys, and said nonmagnetic coupling layer has a thickness of 0.5 to 1.5 nm.

(7) The magnetic recording medium according to any one of claim 1 through claim 4, wherein said nonmagnetic intermediate layer comprises at least one alloy selected from the group consisting of CoCrZr alloys, CoCrTa alloys, CoRu alloys, CoCrRu alloys, CoCrPtZr alloys, CoCrPtTa alloys, CoPtRu alloys, and CoCrPtRu type alloys.

(8) The magnetic recording medium according to any one of claim 1 through claim 7, wherein said nonmagnetic undercoat layer has a multilayer structure including a layer comprising Cr or a Cr alloy comprising Cr and at least one element selected from the group consisting of Ti, Mo, Al, Ta, W, Ni, B, Si, Mn and V, and a layer comprising a multicomponent body-centered cubic crystal alloy.

(9) The magnetic recording medium according to any one of claim 1 through claim 7, wherein said nonmagnetic undercoat layer has a multilayer structure containing a layer comprising NiAl alloys, RuAl alloys, and a multicomponent body-centered cubic crystal alloy.

(10) The magnetic recording medium according to any one of claim 1 through claim 9, wherein said magnetic layer comprises at least one alloy selected from the group consisting of CoCrTa alloys, CoCrPtTa alloys, CoCrPtB alloys, and CoCrPtBM (where M is one or more elements selected from Ta, Cu, and Ag) alloys.

(11) The magnetic recording medium according to any one of claim 1 through claim 10, wherein said nonmagnetic substrate is a glass substrate or a silicon substrate.

(12) The magnetic recording medium according to any one of claim 1 through claim 10, wherein said nonmagnetic substrate is a substrate where a film comprising NiP or a NiP alloy is formed on the surface of a substrate selected from the group of Al, Al alloy, glass, and silicon.

(13) A method of producing a magnetic recording medium having at least a nonmagnetic undercoat layer, a nonmagnetic intermediate layer, a magnetic layer, and a protective layer laminated in this order on a nonmagnetic substrate, wherein at least one layer of said nonmagnetic undercoat layer is constituted by a multicomponent body-centered cubic crystal alloy.

(14) A method of producing a magnetic recording medium having at least a nonmagnetic undercoat layer, a stabilizing layer, a nonmagnetic coupling layer, a magnetic layer, and a protective layer laminated in the ascending order on a nonmagnetic substrate, wherein said stabilizing layer is antiferromagnetically bonded to said magnetic layer, and at least one layer of said nonmagnetic undercoat layer is constituted by a multicomponent body-centered cubic crystal alloy.

(15) A magnetic recording and reproducing apparatus comprising a magnetic recording medium according to any one of claim 1 through claim 14, and a magnetic head which records and reproduces information on said magnetic recording medium.

### BRIEF DESCRIPTION OF THE DRAWINGS

FIG. 1 is a cross-sectional view showing a first embodiment of a perpendicular magnetic recording medium of the present invention.

FIG. 2 is a cross-sectional view showing a second embodiment of a perpendicular magnetic recording medium of the present invention.

FIG. 3 is a block diagram showing one example of a magnetic recording and reproducing apparatus of the present invention.

### BRIEF DESCRIPTION OF THE REFERENCE SYMBOLS

1 Nonmagnetic substrate, 2 Nonmagnetic undercoat layer, 3 Nonmagnetic intermediate layer, 4 Magnetic layer, 5 Protective layer, 6 Lubricant layer, 7 Stabilizing layer, 8 Nonmagnetic coupling layer, 10 Magnetic recording medium, 11 Magnetic recording medium, 12 Magnetic recording and reproducing apparatus, 13 Medium drive unit, 14 Magnetic head, 15 Head drive unit, 16 Record reproduction signal processing system

### BEST MODE FOR CARRYING OUT THE INVENTION

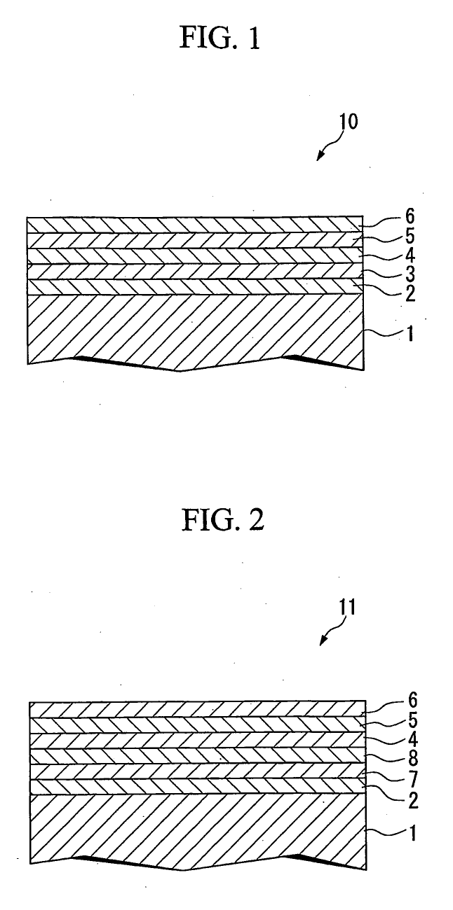

FIG. 1 shows a magnetic recording medium according to a first embodiment of the present invention. The magnetic recording medium 10 shown in FIG. 1 is one in which a nonmagnetic undercoat layer 2, a nonmagnetic intermediate layer 3, a magnetic layer 4, a protective layer 5, and a lubricant film 6 are sequentially laminated on a nonmagnetic substrate 1.

FIG. 2 shows a magnetic recording medium according to a second embodiment of the present invention. The magnetic recording medium 10 shown in FIG. 2 is one in which a nonmagnetic undercoat layer 2, a stabilizing layer 7, a nonmagnetic coupling layer 8, a magnetic layer 4, protective layer 5, and a lubricant layer 6 are sequentially laminated on a nonmagnetic substrate 1. The film configuration shown in FIG. 2 is a technology designed to prevent thermal fluctuation of the magnetic layer. In a magnetic recording medium utilizing this technology, since magnetization directions of two magnetic layers are mutually inverted, the section participating in magnetic recording and magnetic reproduction substantially becomes thinner than the thickness of the whole recording film. Therefore, it is possible for the SNR to be improved. On the other hand, it is possible to improve the thermal instability, because total volume of crystal grains of the whole recording layer becomes large.

A medium utilizing this technology is generally called an AFC medium (Antiferromagnetically-Coupled Media), or an SFM (Synthetic Ferrimagnetic Media). Here, these will be generically called AFC mediums.

As the nonmagnetic substrate 1 in the present invention, a metallic substrate made of a metallic material such as Al, and Al alloy is used, on which a film made of NiP or NiP alloy formed is provided. As the nonmagnetic substrate 1, nonmetallic materials such as glass, ceramics, silicon, silicon carbide, carbon, and resin may be used, or one in which an NiP or NiP alloy film has been formed on a substrate made of nonmetallic material may be used. As the nonmetallic material, from the point of surface smoothness, one type selected from glass or silicon is desirable. In particular, from the point of cost and durability, it is desirable to use glass. As glass, crystallized glass or amorphous glass may be used. As amorphous glass, general purpose soda-lime glass, alumino-borosilicate glass, or alumino-silicate glass may be used. As a crystallized glass, lithium crystallized glass may be used. As a ceramic substrate, a sintered body or a fiber-reinforced material thereof of general purpose aluminum oxide, silicon nitride, and the like, as its principal component can be adopted. Since lowering of the flying height of the magnetic head is required to increase the recording density, it is preferable to increase the surface smoothness of the nonmagnetic substrate 1. That is to say, it is preferable for the surface average roughness Ra of the nonmagnetic substrate 1 to be not greater than 2 nm, and preferably not greater than 1 nm.

It is preferable to form texture mark by texture processing on the surface of the nonmagnetic substrate 1. In texture processing, it is desirable for the average roughness of the substrate surface to be made not less than 0.1 nm and not greater than 0.7 nm (more preferably not less than 0.1 nm and not greater than 0.5 nm, and still more preferably not less than 0.1 nm and not greater than 0.35 nm). From the point of strengthening the magnetic anisotropy in the circumferential direction of the magnetic recording medium, it is preferable for the texture mark to be formed approximately in the circumferential direction. It is preferable for the micro-waviness (Wa) of the surface nonmagnetic substrate 1 to be not greater than 0.3 nm (more preferably not greater than 0.25 nm). Furthermore, for the flight stability of the magnetic head, it is preferable to make the surface average roughness Ra of at least one of either the chamfered surface of chamfer portion of the end face or the side face, to be not greater than 10 nm (more preferably not greater than 9.5 nm). The micro-waviness (Wa) can, for example, be measured as a surface average roughness at a measuring range of 80 μm, by utilizing a surface roughness measuring apparatus P-12 (product of KLM-Tencor).

The nonmagnetic undercoat layer 2 is formed on the nonmagnetic substrate. It is preferable to use a pluralistic body-centered cubic crystal alloy and to comprise at least one element selected from the A group consisting of Cr and V, at least one element selected from the B group consisting of Mo and W, and at least one element selected from the C group consisting of Nb, Ta and Ti.

Moreover, it is also preferable that the content of at least one elements selected from the A group is in total 10 to 60 at %, the content of at least one element selected from the B group is in total 10 to 80 at %, and the content of at least one element selected from the C group is in total 10 to 60 at %.

It is further desirable the multicomponent body-centered cubic crystal alloy has a lattice constant within a range of 3.02 to 3.14 Å.

Addition of elements such as W, Mo, and V to Cr has an effect of expanding the lattice constant, and is conventionally widely performed for matching with Co alloys. However, in recent years, because of the increase in the lattice constants of Co alloys from the increased addition of Pt to Co alloys, and the use of Ru alloys which have a larger lattice constant than Co alloys, a need to further expand the lattice constants is emerging. Cr, W, Mo, and V all take the same bcc structure, and their lattice constants are 2.88 Å for Cr, 3.16 Å for W, 3.14 Å for Mo, and 3.02 Å for V. For optimal matching with Co alloys or Ru alloys with a Pt content of 8 to 16 at %, Cr and V are too small, and W and Mo are too large. To resolve this problem, it is effective to adjust the lattice constant by addition of V to W and Mo, as disclosed by the present inventors in Japanese Patent Application No. 2005-08205, and it is possible to achieve an optimal matching.

In the present invention, this way of thinking was progressed, and a multicomponent body-centered cubic crystal alloy with a lattice constant of 3.05 to 3.14 Å was made by combining the large lattice constant Nb (3.30 Å), Ta (3.30 Å), Ti (3.13 Å), the intermediate lattice constant Mo, W, and the small lattice constant V, Cr, so that the optimum match could be reached. Moreover, as shown in the present example, in the case of a ternary or higher multicomponent body-centered cubic crystal alloy of the present invention, it was confined that the characteristic lattice constant were improved up to 3.20 Å.

To the multicomponent body-centered cubic crystal alloy utilized in the nonmagnetic undercoat layer 2 of the present invention, an element which has an auxiliary effect may be added. Examples of such additional elements includes B, C, Al, Si, Mn, Cu, Ru, Hf, Re, and the like. It is desirable for the total content of the additional elements to be not greater than 20 at %. If the total content exceeds 20 at %, the effect of the above-mentioned orientation adjustment layer decreases. The lower limit of the total content is 0.1 at %. At a content of less than 0.1 at %, the effect of the additional element is lost. The effect of adding B is especially large, and greatly contributes to noise reduction.

In a situation where the nonmagnetic undercoat layer 2 of the present invention is constituted by not less than two layers, a multicomponent body-centered cubic crystal alloy is utilized as one layer close in position to the nonmagnetic intermediate layer 3. However, for the other layers, a Cr layer, or a Cr alloy layer containing at least one type selected from the group consisting of Ti, Mo, Al, Ta, W, Ni, B, Si, Mn and V may be used. Alternatively, a layer containing a NiAl type alloy, or a RuAl type alloy may also be used.

It is desirable that the film thickness of the nonmagnetic undercoat layer 2 of the present invention is within a range of 10 Å to 300 Å. When a thickness of the nonmagnetic undercoat layer 2 film is less than 10 Å, the crystalline orientation of the nonmagnetic undercoat layer 2 becomes insufficient, lowering its coercive force. If the nonmagnetic undercoat layer 2 film thickness exceeds 300 Å, the magnetic anisotropy of the magnetic layer 4 in the circumferential direction decreases. More desirable is a multicomponent body-centered cubic crystal alloy film with a film thickness in the range of 5 Å to 100 Å. A Cr layer or a Cr alloy layer, or a NiAl type alloy, a RuAl type alloy or the like with a film thickness in the range of 5 Å to 100 Å, is desirable for improving the coercive force and rectangularity of the magnetic layer 4. It is desirable for the crystalline orientation of the multicomponent body-centered cubic crystal alloy of the nonmagnetic undercoat layer 2 to have the (100) plane as the preferred orientation plane. As a result, the crystalline orientation of the Co alloy of the magnetic layer 4 formed on the nonmagnetic undercoat layer 2 is more strongly (11·0) expressed, and therefore improvements in the magnetic properties, for example coercive force (Hc), and improvements in record reproduction performance, for example SNR, can be obtained.

For the nonmagnetic intermediate layer 3 of the present invention, it is desirable to use a material having a hcp structure and having a lattice constant matching sufficiently well to, for example, the (100) plane of the nonmagnetic undercoat layer 2 therebeneath. For example, it is desirable to use a material including more than one alloy selected from the group consisting of a CoCr type alloy, a CoCrPt type alloy, Ru, an Ru alloy, Re, an Re alloy. It is desirable that the film thickness of the nonmagnetic intermediate layer 3 is in the range of 10 Å to 100 Å. When a film thickness of the nonmagnetic intermediate layer 3 is less than 10 Å, the crystal orientation effect of the nonmagnetic undercoat layer 2 is insufficient and its coercive force is reduced. If the film thickness of the nonmagnetic intermediate layer 3 exceeds 100 Å, the grains become large, causing an increase in noise.

For the magnetic layer 4 of the present invention, it is desirable that the magnetic layer 4 is selected from the group consisting of a Co—Cr—Ta type, a Co—Cr—Pt type, a Co—Cr—Pt—Ta type, a Co—Cr—Pt—B—Ta type, a Co—Cr—Pt—B—Cu type alloy, or a Co—Cr—Pt—B—Ag type alloy. For example, in the case of a Co—Cr—Pt type alloy, from the point of view of SNR improvement, it is desirable to have a Cr content in the range of 10 at % to 27 at %, and a Pt content in the range of 8 at % to 16 at %. For example, in the case of a Co—Cr—Pt—B type alloy, from the point of view of SNR improvement, it is desirable to have a Cr content in the range of 10 at % to 27 at %, a Pt content in the range of 8 at % to 16 at %, and a B content in the range of 1 at % to 20 at %. For example, in the case of a Co—Cr—Pt—B—Ta type alloy, from the point of SNR improvement, it is desirable to have a Cr content in the range of 10 at % to 27 at %, a Pt content in the range of 8 at % to 16 at %, a B content in the range of 1 at % to 20 at %, and a Ta content in the range of 1 at % to 4 at %. For example, in the case of a Co—Cr—Pt—B—Cu type alloy, from the point of view of SNR improvement, it is desirable to have a Cr content in the range of 10 a % to 27 at %, a Pt content in the range of 8 at % to 16 at %, a B content in the range of 2 at % to 20 at %, and a Cu content in the range of 1 at % to 10 at %. For example, in the case of a Co—Cr—Pt—B—Ag type alloy, from the viewpoint of SNR improvement, it is desirable to have a Cr content in the range of 10 at % to 27 at %, a Pt content in the range of 8 at % to 16 at %, a B content in the range of 2 at % to 20 at %, and a Cu content in the range of 1 at % to 10 at %.

If the film thickness of the magnetic layer 4 is greater or equal to 10 nm, there is no problem from the viewpoint of thermal fluctuation, however it is desirable that the film thickness is less or equal to 40 nm when high recording density is desired. This is because if the film thickness exceeds 40 mm, the grain size of the magnetic layer 4 increases, and it becomes unable to obtain desirable record reproduction performance. The magnetic layer 4 may have a multilayered structure, and the materials thereof may be combined by selecting a plurality of materials from the listing of materials shown above. In the case when the magnetic layer 4 is formed by a multilayered structure, from the viewpoints of record reproduction performance and SNR characteristic improvement, it is desirable to form the magnetic layer directly on the nonmagnetic intermediate layer 3, formed by any one of a Co—Cr—Pt—B—Ta type alloy, a Co—Cr—Pt—B—Cu type alloy, or a Co—Cr—Pt—B type alloy. From the viewpoint of record reproduction performance and SNR characteristic improvement, it is desirable for the top layer to comprise a Co—Cr—Pt—B—Cu type alloy or a Co—Cr—Pt—B type alloy.

For the stabilizing layer 7 of the present invention, it is desirable to use an alloy selected from the group consisting of a CoCrZr type alloy, a CoCrTa type alloy, a CoRu type alloy, a CoCrRu type alloy, a CoCrPtZr type alloy, a CoCrPtTa type alloy, a CoPtRu type alloy, or a CoCrPtRu type alloy. It is desirable that the film thickness of the stabilizing layer 7 is in the range of 10 Å to 50 Å. When the film thickness of the stabilizing layer 7 is less than 10 Å, the stabilizing layer 7 no longer holds magnetization, and the stabilizing layer 7 does not antiferromagnetically couple to the magnetic layer 4, through the nonmagnetic coupling layer 8 between the stabilizing layer 7 and the magnetic layer 4. If the film thickness of the stabilizing layer 7 exceeds 50 Å, the grains become large, causing an increase in noise.

For the nonmagnetic coupling layer 8 of the present invention, it is desirable to select a material from the group consisting of Ru, Rh, Ir, Cr, Re, an Ru type alloy, an Rh type alloy, an Ir alloy, a Cr alloy, or an Re alloy. In particular, it is further desirable to utilize Ru. If the film thickness of Ru is approximately 0.8 nm, the antiferromagnetic binding increases to the maximum, which is desirable.

For the above-described protective layer 5, it is possible to use a conventionally known material, for example, a simple substance of carbon or SiC, or a material containing those as their principal components. For the protective layer 5, it is desirable that the film thickness is in the range of 1 nm to 10 nm from the viewpoint for decreasing the magnetic spacing and increasing durability, when the protective layer is applied to a high density recording medium. Magnetic spacing expresses the distance between the read/write element of the magnetic head, and the magnetic layer 4. The narrower the magnetic spacing becomes, the more the electromagnetic transfer characteristics improve. Since the protective layer 5 exists between the read/write element of the head, and the magnetic layer 4, the film thickness of the protective layer becomes a factor in widening the magnetic spacing. A lubricating layer 6 includes, for example, a fluorine containing lubricant such as perfluoropolyether fluorine lubricant may be provided on the protective film when necessary.

It is desirable for the magnetic layer 4 of the magnetic recording medium of the present invention to have a magnetization orientation ratio (OR) of not less than 1.05 (more preferably not less than 1.1). The magnetization orientation ratio is expressed by (coercive force in the circumferential direction/coercive force in the radial direction). If the magnetization orientation ratio is not less than 1.05, an improvement in the magnetic characteristics, such as the coercive force, and an improvement in the electromagnetic transfer characteristics, for example SNR, PW50, can be obtained. The magnetization orientation ratio is defined as the ratio between the coercive force (Hc) in the circumferential direction and the coercive force (Hc) in the radial direction. However, because the coercive force of the magnetic recording medium has become high, the magnetization orientation ratio is measured to be low in some cases.

In the present invention, to supplement the above point, the magnetization orientation ratio of the residual magnetization amount is used together. The magnetization orientation ratio (MrtOR) of the residual magnetization amount is defined as the ratio between the residual magnetization amount in the circumferential direction (Mrt) and the residual magnetization amount in the radial direction (Mrt) (MrtOR=Mrt in the circumferential direction/Mrt in the radial direction). If the magnetization orientation ratio of the residual magnetization amount is not less than 1.05, and more preferably not less than 1.1, an improvement in the magnetic characteristics, for example the coercive force, and an improvement in the electromagnetic transfer characteristics, for example SNR, PW50, can be obtained. The upper limit of the value of OR and MrtOR is in an ideal situation where all of the magnetic domains of the magnetic film are directed in the circumferential direction, and in this situation the denominator of the magnetization orientation ratio becomes zero, so that it becomes infinite. For the measurement of the magnetization orientation ratio and magnetization orientation ratio of the residual magnetization amount, a VSM (Vibrating Sample Magnetometer) is used.

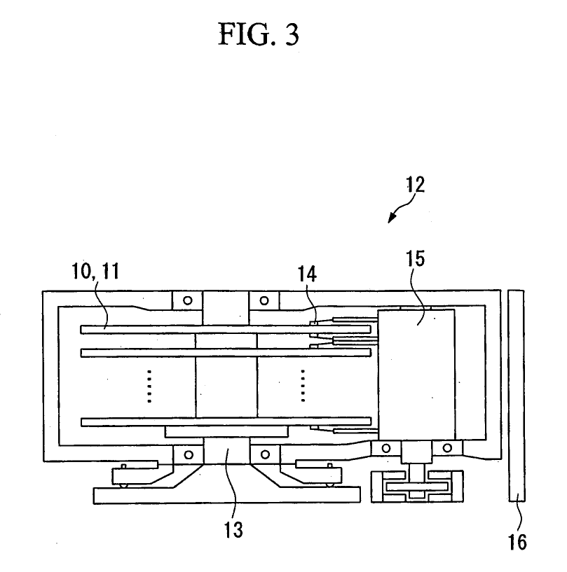

FIG. 3 shows an example of a magnetic recording and reproducing apparatus utilizing the above-mentioned magnetic recording medium.

The magnetic recording and reproducing apparatus 12 shown in FIG. 3 comprises a magnetic recording medium 10 with a configuration shown in FIG. 1, or a magnetic recording medium 11 with a configuration shown in FIG. 2, a medium drive unit 13 that rotates the magnetic recording medium 10, 11, a magnetic head 14 that records and reproduces the information in the magnetic recording medium 10, 11, a head drive unit 15 that relatively moves the magnetic head 14 with respect to the magnetic recording medium 10, 11, and a record reproduction signal processing system 16. The record reproduction signal processing system 16 is able to process the data input from the outside and send the record signal to the magnetic head 14, and process the reproduction signal from the magnetic head 14 and send the data to the outside. For the magnetic head 14 used in the magnetic recording and reproducing apparatus 12 of the present invention, not only an MR (magnetoresistance) element utilizing a giant magnetoresistance effect (GMR) as the reproduction element, but also a magnetic head more suitable for high recording density which has a GMR element using a tunnel magnetoresistance (TMR) effect, and the like, may be used.

Furthermore, the magnetic recording and reproducing apparatus 12 of the present invention uses a magnetic recording medium 10, 11, which has a small average roughness and small micro-waviness. Therefore in addition to the improved electromagnetic transfer characteristics, the magnetic recording and reproducing apparatus is one with good error characteristics when the magnetic head is used at a low floating height in order to decrease the spacing loss. According to the above-mentioned magnetic recording and reproducing apparatus 12, it becomes possible to manufacture a magnetic recording medium suitable for high recording density.

Next, one example of a manufacturing method of the magnetic recording medium according to the present invention is explained. For the nonmagnetic substrate 1, any of the substrate materials mentioned above may be used as substrate for the magnetic recording medium (10), (11). As one example, a substrate is used, in which a 12 μm NiP plating has been applied to an Al substrate (hereafter called an NiP plated Al substrate).

First, texture processing is applied to the surface of the NiP plated Al substrate, such that texture marks having striations are formed to a line density of not less than 7500 (lines/mm) on the surface of the substrate. For example, a texture is applied in the circumferential direction by machine processing (also known as “mechanical texture processing”) using a fixed abrasive grain and/or a free abrasive grain to form texture striations to a line density of not less than 7500 (lines/mm) on the surface of a glass substrate. For example, a grinding tape is pressed into contact with the surface of the substrate, and a grinding slurry containing the grinding abrasive grain is supplied between the substrate and the grinding tape, and texture processing is performed by both rotation of the substrate and the feeding of the grinding tape.

In the above-described processing, it is possible to rotate the substrate in the range of 200 rpm to 1000 rpm. It is possible to feed the grinding slurry at a feeding rate in the range of 10 mL/min to 100 mL/min. It is possible to feed the grinding tape at a speed in the range of 1.5 mm/min to 150 mm/min. It is possible to select grain size of the abrasive grain contained in the abrasive slurry to be within a range of 0.05 μm to 0.3 μm at D90 (the grain size is determined when the cumulative mass % corresponds to 90 mass %). It is possible to press the tape at a pressing force in a range from 1 kgf to 15 kgf (9.8 N to 147 N (relative pressure)). In order to form the texture mark at a line density of not less than 7500 (lines/mm) (more preferably not less than 20000 (lines/mm)), it is desirable to set these conditions. It is desirable for the surface average roughness Ra of the NiP plated Al substrate with texture marks formed on its surface, to be in the range of 0.1 nm to 1 nm (1 Å to 10 Å), or preferably 0.2 nm to 0.8 nm (2 Å to 8 Å).

It is possible to apply texture processing with additional oscillation. Oscillation is an operation where at the same time as the tape is being put in motion in the circumferential direction of the substrate, the tape is swung in the radial direction of the substrate. It is desirable for the oscillation condition to be 60 times/min to 1200 times/min. As a method of texture processing, it is possible to use a method where texture mark is formed at a line density of not less than 7500 (lines/mm). Other than the aforementioned mechanical texturing method, a method using a fixed abrasive grain, a method using a fixed whetstone, a method using laser processing, can be used. For measuring the line density of the texture striations, for example, as a measurement device, an AFM (Atomic Force Microscope, product of Digital Instruments Co. (US)), can be used.

The measurement conditions of the line density are as follows. The scan width is 1 μm, the scan rate is 1 Hz, the number of samples is 256, and the mode is tapping mode. An AFM scan image is obtained by scanning the probe in the radial direction of the glass substrate which is the sample. A flatten order is set at 2 dimensions, and plane fit auto processing, which is a type of flattening processing, is carried out with respect to the X axis and Y axis of the scan image to perform the flattening correction on the image. With respect to a flatten corrected image, a box of approximately 0.5 μm×0.5 μm is set, and the line density within the region of the box is calculated. The line density is calculated by converting the total number of zero crossover points along both the X axis centerline and the Y axis centerline to a 1 mm scale. That is to say, the line density is the number of peaks and troughs of the texture marks in the radial direction on a 1 mm scale.

Each section in the sample plane is measured, and the average values and standard deviations of the measurement values thereof, are calculated. The average value is determined as the line density of the texture striations of the glass substrate. The number of measurement are set at the number of sections from which the average value and standard deviation is calculated. For example, the measurement number can be made to be 10 points. Furthermore, when the average value and standard deviation are calculated from 8 of these points, excluding the maximum value and the minimum value, abnormal measurement values can be excluded, and it is possible to improve the measurement accuracy.

After the NiP plated Al substrate has been washed, it is installed inside the chamber of a deposition device. The NiP plated Al substrate is heated to 100 to 400° C. as required. The nonmagnetic undercoat layer 2, the nonmagnetic intermediate layer 3, and the magnetic layer 4 are formed on the nonmagnetic substrate by a sputter method (for example a DC or RF magnetron sputtering method). The operating conditions for forming the above-mentioned layers by a sputtering method, for example, are as follows.

The sputtering conditions for forming each film on the NiP plated Al substrate, for example, can be set as follows. The deposition chamber used for deposition is evacuated until the vacuum level is reached in the range of 10⁻⁴ Pa to 10⁻⁷ Pa. Sputter deposition is performed by accommodating a glass substrate, having the texture mark formed on its-surface, in the chamber, and discharging electricity by introducing an Ar gas as a sputter gas. At this time, a electric power supplied for discharging is controlled in a range of 0.2 kW to 2.0 kW, and by adjusting the discharge time and supplied power, the desired film thickness can be obtained.

Hereunder, an example of a formation method of the magnetic recording medium is shown below. The nonmagnetic undercoat layer of a thickness of 3 to 15 nm is formed by using a sputtering target comprising a multicomponent body-centered cubic crystal alloy, Cr, a Cr type alloy, or the like, on the nonmagnetic substrate.

Next, the nonmagnetic intermediate layer 3 at a thickness of 1 to 10 nm is formed by using a sputtering target comprising Ru alloy. Next, the magnetic layer 4 of a thickness of 10 to 40 nm is formed by using a sputtering target comprising a CoCrTa type alloy, a CoCrPt type alloy, a CoCrPtTa type alloy, a CoCrPtB type alloy, a CoCrPtBTa type alloy, a CoCrPtBCu type alloy, a CoRuTa type alloy, or the like. Next, the protective layer 5 of a thickness of 1 to 5 nm is formed by a conventionally known sputtering method or plasma CVD method. Next, if required, the lubricating layer 6 is formed by a conventionally known spin method or dip method. The above-mentioned magnetic recording medium is furnished with a nonmagnetic undercoat layer 2 made of a multicomponent body-centered cubic crystal alloy. Therefore, the medium noise can be decreased.

FIG. 3 shows an example of a magnetic recording and reproducing apparatus using the above-mentioned magnetic recording medium. The magnetic recording and reproducing apparatus 12 shown in FIG. 3 is furnished with a magnetic recording medium 10 of the above-mentioned configuration, a medium drive unit 13 that rotates the magnetic recording medium 10, a magnetic head 14 that records and reproduces the information in the magnetic recording medium 10, a head drive unit 15 that relatively moves the magnetic head 14 with respect to the magnetic recording medium 10, and a record reproduction signal processing system 16. The record reproduction signal processing system 16 is able to process the data input from the outside and send the record signal to the magnetic head 14, and process the reproduction signal from the magnetic head 14 and send the data to the outside.

The magnetic head 14 used in the magnetic recording and reproducing apparatus 12 of the present invention not only uses an MR (magnetoresistance) element utilizing a giant magnetoresistance effect (GMR) as the reproduction element, but also uses a GMR element using a tunnel magnetoresistance (TMR) effect and the like for forming a magnetic head more suitable for high recording density.

The using a TMR element makes it possible to further increases in recording density.

Since the above-mentioned magnetic recording and reproducing apparatus 12 is furnished with the magnetic recording medium 10 using a multicomponent body-centered cubic crystal alloy in the nonmagnetic undercoat layer 2, medium noise can be decreased.

Hereunder, specific examples are shown to clarify the operational effects of the present invention.

### EXAMPLE 1

A nonmagnetic substrate 1 was used, in which an NiP film (thickness 12 μm) formed by electroless deposition on the surface of the substrate made of Al (outside diameter 95 mm, inside diameter 25 mm, thickness 1.270 mm), and the surface average roughness Ra of the substrate was finished to be 0.5 nm by performing texture processing on the substrate surface. The above-described nonmagnetic substrate 1 was accommodated in the chamber of a DC magnetron sputter device (Anerva Corp., C3010), and after the chamber was evacuated to a vacuum level of 2×10⁻⁷ Torr (2.7×10⁻⁵ Pa), the nonmagnetic substrate 1 was heated to 250° C. A nonmagnetic undercoat layer 2 was provided on this substrate. The nonmagnetic undercoat layer 2 was provided to have a multilayer structure, by providing a second undercoat layer (thickness 3 nm) comprising a CrVMoNb alloy (Cr: 50 at %, V: 20 at %, Mo: 20 at %, Nb: 10 at %) on a first undercoat layer (thickness 2 nm) made of Cr.

Next, a nonmagnetic intermediate layer 3 (thickness 4 nm) made of Ru was formed.

Next, magnetic layers 4 were provided. A first magnetic layer (thickness 10 nm) comprising a CoCrPtB alloy (Co: 60 at %, Cr: 25 at %, Pt: 14 at %, B: 6 at %) was formed. Then, on the first magnetic layer, a second magnetic layer (thickness 10 nm) comprising a CoCrPtB alloy (Co: 60 at %, Cr: 10 at %, Pt: 15 at %, B: 15 at %) was formed.

When forming each of the above-mentioned layers, Ar was used as the sputtering gas, and the pressure thereof was maintained at 6 mTorr (0.8 Pa). Next, a protective layer 5 (thickness 3 nm) comprising carbon was formed by CVD. Next, a lubricating layer 6 (thickness 2 nm) was formed by spreading a lubricant comprising perfluoropolyether on the surface of the protective layer 5, and the magnetic recording medium 10 was obtained.

Thereafter, a glide test was performed using a glide tester, with a glide height of 0.4 μinch, which was the test condition. The record reproduction performance of the accepted magnetic recording mediums 10 was examined using a read/write analyzer RWA 1632 (product of GUZIK Co. (US)). For the record reproduction performance, electromagnetic transfer characteristics such as the reproduction signal output (TAA), the half-width (PW50) of the solitary wave reproduction output, the SNR, and the overwrite (OW) were measured. For the evaluation of the record reproduction performance, a complex type thin-film magnetic recording head, which had a giant magnetic resistance (GMR) element in its reproduction section, was used. The measurement of noise was measured by the integral noise from 1 MHz to 375 kFCI equivalent frequency when a 500 KFCI pattern signal was written. The reproduction output was measured at 250 KFCI, and was calculated by SNR=20×log (reproduction output/integral noise from 1 MHz to 375 kFCI equivalent frequency). For the measurement of the coercive force (Hc) and the rectangularity ratio (S*), an electro-optical Kerr effect type magnetic property measurement device (RO1900, product of Hitachi Electrical Engineering Co. (Japan)) was used. For the measurement of the magnetization orientation ratio (OR) and the magnetization orientation ratio (MrtOR) of the residual magnetization amount, a VSM (BHV-35, product of Riken Electrical Co. (Japan)) was used.

### EXAMPLES 2-120

Comparative Examples 2 and 120 were prepared using the same layer structure and the same alloy composition as those of Example 1 shown in Table 1, except for replacing the second undercoat layer of CrVMoNb alloy of the nonmagnetic undercoat layer 2 of Example 1 with the second undercoat layer shown in Tables 1 to 5 having different alloy compositions, and the magnetic recording medium of Example 2 to 120 exhibit magnetic recording and reproduction properties as shown in Table 5. In the table, 1Oe corresponds to approximately 79 μm.

TABLE 1

| | 2nd UNDERCOAT LAYER | | | | | | | | | | | | | | |
|---|---|---|---|---|---|---|---|---|---|---|---|---|---|---|---|
| | | | | | | FILM | LATTICE | COER- | | | | | | | |
| | ALLOY COMPOSITION | | | | | THICK- | CON- | CIVE | ANGU- | | | | | | |
| | Cr | V | Cr + V | Mo | Nb | NESS | STANT | FORCE | LARITY | | | TAA | OW | PW50 | SNR |
| | at % | | | | | nm | Å | Oe | RATIO | HcOR | MrtOR | μV | dB | ns | dB |
| EXAMPLE 1 | 50 | 20 | 70 | 20 | 10 | 3 | 3.00 | 3870 | 0.628 | 1.05 | 1.45 | 1125 | 42.7 | 8.49 | 14.9 |
| EXAMPLE 2 | 60 | 0 | 60 | 30 | 10 | 3 | 3.00 | 3807 | 0.523 | 1.06 | 1.51 | 1180 | 43.6 | 8.58 | 12.0 |
| EXAMPLE 3 | 40 | 40 | 80 | 10 | 10 | 3 | 3.01 | 3522 | 0.305 | 1.07 | 1.65 | 1317 | 45.6 | 8.44 | 8.2 |
| EXAMPLE 4 | 60 | 10 | 70 | 10 | 20 | 3 | 3.01 | 4056 | 0.706 | 1.06 | 1.56 | 1197 | 40.0 | 9.46 | 15.4 |
| EXAMPLE 5 | 50 | 10 | 60 | 30 | 10 | 3 | 3.02 | 4058 | 0.705 | 1.08 | 1.71 | 1311 | 40.7 | 8.45 | 16.1 |
| EXAMPLE 6 | 40 | 30 | 70 | 20 | 10 | 3 | 3.02 | 3831 | 0.611 | 1.08 | 1.72 | 1364 | 41.8 | 8.14 | 14.2 |
| EXAMPLE 7 | 60 | 0 | 60 | 20 | 20 | 3 | 3.02 | 4165 | 0.796 | 1.09 | 1.73 | 1341 | 38.6 | 8.39 | 19.3 |
| EXAMPLE 8 | 30 | 50 | 80 | 10 | 10 | 3 | 3.02 | 3896 | 0.545 | 1.09 | 1.71 | 1306 | 41.6 | 8.19 | 11.2 |
| EXAMPLE 9 | 50 | 20 | 70 | 10 | 20 | 3 | 3.02 | 4040 | 0.732 | 1.08 | 1.73 | 1314 | 40.0 | 8.76 | 17.3 |
| EXAMPLE 10 | 50 | 0 | 50 | 40 | 10 | 3 | 3.03 | 4180 | 0.770 | 1.10 | 1.73 | 1345 | 38.4 | 8.13 | 18.3 |
| EXAMPLE 11 | 40 | 20 | 60 | 30 | 10 | 3 | 3.03 | 4155 | 0.739 | 1.12 | 1.72 | 1357 | 39.1 | 8.34 | 16.8 |
| EXAMPLE 12 | 30 | 40 | 70 | 20 | 10 | 3 | 3.03 | 4043 | 0.648 | 1.12 | 1.68 | 1288 | 41.2 | 8.06 | 14.5 |
| EXAMPLE 13 | 50 | 10 | 60 | 20 | 20 | 3 | 3.03 | 4188 | 0.794 | 1.10 | 1.69 | 1313 | 39.9 | 8.36 | 19.9 |
| EXAMPLE 14 | 20 | 60 | 80 | 10 | 10 | 3 | 3.03 | 4022 | 0.604 | 1.12 | 1.70 | 1299 | 41.7 | 8.07 | 14.2 |
| EXAMPLE 15 | 40 | 30 | 70 | 10 | 20 | 3 | 3.03 | 4157 | 0.773 | 1.11 | 1.70 | 1364 | 38.6 | 8.14 | 18.9 |
| EXAMPLE 16 | 60 | 0 | 60 | 10 | 30 | 3 | 3.03 | 4198 | 0.813 | 1.11 | 1.69 | 1340 | 39.0 | 8.44 | 19.8 |
| EXAMPLE 17 | 40 | 10 | 50 | 40 | 10 | 3 | 3.04 | 4224 | 0.788 | 1.10 | 1.68 | 1269 | 39.4 | 8.04 | 19.4 |
| EXAMPLE 18 | 30 | 30 | 60 | 30 | 10 | 3 | 3.05 | 4083 | 0.754 | 1.11 | 1.70 | 1323 | 41.0 | 8.15 | 17.8 |
| EXAMPLE 19 | 50 | 0 | 50 | 30 | 20 | 3 | 3.05 | 4195 | 0.816 | 1.12 | 1.69 | 1312 | 38.2 | 8.15 | 20.3 |
| EXAMPLE 20 | 20 | 50 | 70 | 20 | 10 | 3 | 3.05 | 4178 | 0.735 | 1.12 | 1.68 | 1322 | 39.9 | 8.02 | 16.1 |
| EXAMPLE 21 | 40 | 20 | 60 | 20 | 20 | 3 | 3.05 | 4293 | 0.807 | 1.11 | 1.70 | 1283 | 37.3 | 8.29 | 19.2 |
| EXAMPLE 22 | 30 | 40 | 70 | 10 | 20 | 3 | 3.05 | 4129 | 0.782 | 1.12 | 1.68 | 1316 | 39.4 | 8.16 | 18.8 |
| EXAMPLE 23 | 50 | 10 | 60 | 10 | 30 | 3 | 3.05 | 4276 | 0.821 | 1.10 | 1.70 | 1284 | 38.9 | 8.10 | 19.2 |
| EXAMPLE 24 | 40 | 0 | 40 | 50 | 10 | 3 | 3.06 | 4211 | 0.806 | 1.12 | 1.70 | 1293 | 39.6 | 8.12 | 19.8 |
| EXAMPLE 25 | 30 | 20 | 50 | 40 | 10 | 3 | 3.06 | 4267 | 0.797 | 1.12 | 1.70 | 1278 | 39.0 | 8.11 | 19.7 |

TABLE 2

| | 2nd UNDERCOAT LAYER | | | | | | | | | | | | | | |
|---|---|---|---|---|---|---|---|---|---|---|---|---|---|---|---|
| | | | | | | FILM | LATTICE | COER- | | | | | | | |
| | ALLOY COMPOSITION | | | | | THICK- | CON- | CIVE | ANGU- | | | | | | |
| | Cr | V | Cr + V | Mo | Nb | NESS | STANT | FORCE | LARITY | | | TAA | OW | PW50 | SNR |
| | at % | | | | | nm | Å | Oe | RATIO | HcOR | MrtOR | μV | dB | ns | dB |
| EXAMPLE 26 | 20 | 40 | 60 | 30 | 10 | 3 | 3.06 | 4267 | 0.764 | 1.10 | 1.70 | 1295 | 38.1 | 8.05 | 17.9 |
| EXAMPLE 27 | 40 | 10 | 50 | 30 | 20 | 3 | 3.06 | 4271 | 0.813 | 1.10 | 1.69 | 1321 | 38.0 | 8.10 | 20.5 |
| EXAMPLE 28 | 30 | 30 | 60 | 20 | 20 | 3 | 3.06 | 4174 | 0.806 | 1.11 | 1.70 | 1365 | 38.6 | 8.09 | 19.0 |
| EXAMPLE 29 | 50 | 0 | 50 | 20 | 30 | 3 | 3.06 | 4200 | 0.824 | 1.12 | 1.70 | 1276 | 38.9 | 8.02 | 20.7 |
| EXAMPLE 30 | 20 | 50 | 70 | 10 | 20 | 3 | 3.06 | 4259 | 0.780 | 1.10 | 1.68 | 1326 | 39.3 | 8.00 | 18.4 |
| EXAMPLE 31 | 40 | 20 | 60 | 10 | 30 | 3 | 3.06 | 4321 | 0.824 | 1.11 | 1.69 | 1294 | 37.7 | 8.09 | 20.2 |
| EXAMPLE 32 | 30 | 10 | 40 | 50 | 10 | 3 | 3.07 | 4289 | 0.816 | 1.10 | 1.70 | 1363 | 39.0 | 8.05 | 20.2 |
| EXAMPLE 33 | 20 | 30 | 50 | 40 | 10 | 3 | 3.07 | 4198 | 0.802 | 1.11 | 1.70 | 1301 | 38.5 | 8.00 | 19.8 |
| EXAMPLE 34 | 40 | 0 | 40 | 40 | 20 | 3 | 3.07 | 4215 | 0.820 | 1.11 | 1.70 | 1337 | 38.5 | 8.01 | 20.6 |
| EXAMPLE 35 | 30 | 20 | 50 | 30 | 20 | 3 | 3.07 | 4336 | 0.823 | 1.12 | 1.68 | 1277 | 37.0 | 8.02 | 20.2 |
| EXAMPLE 36 | 20 | 40 | 60 | 20 | 20 | 3 | 3.07 | 4299 | 0.802 | 1.10 | 1.70 | 1315 | 37.7 | 8.11 | 20.3 |
| EXAMPLE 37 | 40 | 10 | 50 | 20 | 30 | 3 | 3.07 | 4237 | 0.820 | 1.10 | 1.69 | 1341 | 38.8 | 8.00 | 20.2 |
| EXAMPLE 38 | 30 | 30 | 60 | 10 | 30 | 3 | 3.08 | 4289 | 0.820 | 1.11 | 1.70 | 1296 | 37.8 | 8.11 | 20.6 |
| EXAMPLE 39 | 50 | 0 | 50 | 10 | 40 | 3 | 3.08 | 4228 | 0.830 | 1.10 | 1.69 | 1285 | 37.8 | 8.02 | 20.2 |
| EXAMPLE 40 | 30 | 0 | 30 | 60 | 10 | 3 | 3.08 | 4334 | 0.819 | 1.11 | 1.71 | 1367 | 38.0 | 8.06 | 20.3 |
| EXAMPLE 41 | 20 | 20 | 40 | 50 | 10 | 3 | 3.09 | 4299 | 0.814 | 1.11 | 1.68 | 1354 | 37.8 | 8.03 | 20.3 |
| EXAMPLE 42 | 10 | 40 | 50 | 40 | 10 | 3 | 3.09 | 4344 | 0.806 | 1.10 | 1.71 | 1294 | 37.9 | 8.08 | 20.2 |
| EXAMPLE 43 | 30 | 10 | 40 | 40 | 20 | 3 | 3.09 | 4274 | 0.820 | 1.12 | 1.69 | 1365 | 39.2 | 8.04 | 20.8 |
| EXAMPLE 44 | 20 | 30 | 50 | 30 | 20 | 3 | 3.09 | 4210 | 0.817 | 1.10 | 1.68 | 1263 | 38.5 | 8.04 | 20.0 |
| EXAMPLE 45 | 40 | 0 | 40 | 30 | 30 | 3 | 3.09 | 4188 | 0.828 | 1.10 | 1.70 | 1370 | 39.7 | 8.03 | 20.8 |
| EXAMPLE 46 | 30 | 20 | 50 | 20 | 30 | 3 | 3.09 | 4320 | 0.824 | 1.11 | 1.72 | 1329 | 38.3 | 8.08 | 20.3 |
| EXAMPLE 47 | 20 | 40 | 60 | 10 | 30 | 3 | 3.09 | 4295 | 0.822 | 1.12 | 1.73 | 1316 | 38.0 | 8.14 | 20.2 |
| EXAMPLE 48 | 40 | 10 | 50 | 10 | 40 | 3 | 3.09 | 4267 | 0.829 | 1.11 | 1.69 | 1269 | 37.9 | 8.00 | 20.5 |
| EXAMPLE 49 | 20 | 10 | 30 | 60 | 10 | 3 | 3.10 | 4334 | 0.821 | 1.10 | 1.71 | 1290 | 37.6 | 7.99 | 20.5 |
| EXAMPLE 50 | 10 | 30 | 40 | 50 | 10 | 3 | 3.10 | 4250 | 0.818 | 1.10 | 1.69 | 1317 | 38.6 | 8.11 | 20.1 |

TABLE 3

| | 2nd UNDERCOAT LAYER | | | | | | | | | | | | | | |
|---|---|---|---|---|---|---|---|---|---|---|---|---|---|---|---|
| | | | | | | FILM | LATTICE | COER- | | | | | | | |
| | ALLOY COMPOSITION | | | | | THICK- | CON- | CIVE | ANGU- | | | | | | |
| | Cr | V | Cr + V | Mo | Nb | NESS | STANT | FORCE | LARITY | | | TAA | OW | PW50 | SNR |
| | at % | | | | | nm | Å | Oe | RATIO | HcOR | MrtOR | μV | dB | ns | dB |
| EXAMPLE 51 | 30 | 0 | 30 | 50 | 20 | 3 | 3.10 | 4219 | 0.817 | 1.12 | 1.68 | 1271 | 39.7 | 8.01 | 20.0 |
| EXAMPLE 52 | 20 | 20 | 40 | 40 | 20 | 3 | 3.10 | 4302 | 0.818 | 1.12 | 1.71 | 1360 | 38.9 | 8.01 | 20.4 |
| EXAMPLE 53 | 10 | 40 | 50 | 30 | 20 | 3 | 3.10 | 4348 | 0.817 | 1.11 | 1.68 | 1359 | 37.0 | 7.97 | 20.3 |
| EXAMPLE 54 | 30 | 10 | 40 | 30 | 30 | 3 | 3.10 | 4255 | 0.823 | 1.12 | 1.70 | 1291 | 39.5 | 7.95 | 21.0 |
| EXAMPLE 55 | 20 | 30 | 50 | 20 | 30 | 3 | 3.10 | 4184 | 0.818 | 1.11 | 1.69 | 1332 | 39.5 | 8.05 | 20.1 |
| EXAMPLE 56 | 40 | 0 | 40 | 20 | 40 | 3 | 3.10 | 4173 | 0.822 | 1.11 | 1.73 | 1307 | 38.7 | 8.06 | 20.6 |
| EXAMPLE 57 | 30 | 20 | 50 | 10 | 40 | 3 | 3.10 | 4275 | 0.825 | 1.10 | 1.69 | 1334 | 38.8 | 8.06 | 20.1 |
| EXAMPLE 58 | 20 | 0 | 20 | 70 | 10 | 3 | 3.11 | 4299 | 0.817 | 1.11 | 1.70 | 1352 | 38.7 | 8.06 | 20.2 |
| EXAMPLE 59 | 10 | 20 | 30 | 60 | 10 | 3 | 3.11 | 4329 | 0.818 | 1.11 | 1.71 | 1378 | 37.6 | 8.10 | 20.1 |
| EXAMPLE 60 | 20 | 10 | 30 | 50 | 20 | 3 | 3.11 | 4281 | 0.820 | 1.10 | 1.68 | 1336 | 37.9 | 7.99 | 21.0 |
| EXAMPLE 61 | 10 | 30 | 40 | 40 | 20 | 3 | 3.11 | 4221 | 0.820 | 1.12 | 1.69 | 1275 | 39.3 | 7.99 | 20.2 |
| EXAMPLE 62 | 30 | 0 | 30 | 40 | 30 | 3 | 3.11 | 4180 | 0.821 | 1.12 | 1.72 | 1334 | 39.9 | 7.96 | 20.9 |
| EXAMPLE 63 | 20 | 20 | 40 | 30 | 30 | 3 | 3.12 | 4302 | 0.826 | 1.12 | 1.69 | 1276 | 38.1 | 7.96 | 20.1 |
| EXAMPLE 64 | 10 | 40 | 50 | 20 | 30 | 3 | 3.12 | 4323 | 0.819 | 1.12 | 1.71 | 1365 | 37.5 | 8.09 | 20.1 |
| EXAMPLE 65 | 30 | 10 | 40 | 20 | 40 | 3 | 3.12 | 4199 | 0.819 | 1.10 | 1.68 | 1312 | 39.8 | 8.02 | 20.2 |
| EXAMPLE 66 | 20 | 30 | 50 | 10 | 40 | 3 | 3.12 | 4233 | 0.824 | 1.10 | 1.69 | 1307 | 38.1 | 8.08 | 20.8 |
| EXAMPLE 67 | 40 | 0 | 40 | 10 | 50 | 3 | 3.12 | 4184 | 0.827 | 1.12 | 1.69 | 1314 | 40.0 | 8.02 | 20.0 |
| EXAMPLE 68 | 10 | 10 | 20 | 70 | 10 | 3 | 3.13 | 4295 | 0.822 | 1.11 | 1.71 | 1287 | 39.0 | 8.15 | 20.2 |
| EXAMPLE 69 | 20 | 0 | 20 | 60 | 20 | 3 | 3.13 | 4238 | 0.819 | 1.10 | 1.68 | 1314 | 39.0 | 8.09 | 19.9 |
| EXAMPLE 70 | 10 | 20 | 30 | 50 | 20 | 3 | 3.13 | 4295 | 0.820 | 1.11 | 1.70 | 1330 | 38.8 | 8.06 | 20.2 |
| EXAMPLE 71 | 20 | 10 | 30 | 40 | 30 | 3 | 3.13 | 4244 | 0.820 | 1.12 | 1.69 | 1277 | 38.9 | 8.02 | 20.9 |
| EXAMPLE 72 | 10 | 30 | 40 | 30 | 30 | 3 | 3.13 | 4190 | 0.819 | 1.10 | 1.68 | 1351 | 39.8 | 8.11 | 20.3 |
| EXAMPLE 73 | 30 | 0 | 30 | 30 | 40 | 3 | 3.13 | 4156 | 0.823 | 1.12 | 1.69 | 1272 | 39.8 | 7.98 | 20.6 |
| EXAMPLE 74 | 20 | 20 | 40 | 20 | 40 | 3 | 3.13 | 4269 | 0.822 | 1.11 | 1.71 | 1323 | 39.3 | 7.95 | 20.1 |
| EXAMPLE 75 | 10 | 40 | 50 | 10 | 40 | 3 | 3.13 | 4170 | 0.820 | 1.10 | 1.69 | 1367 | 39.9 | 8.19 | 20.2 |

TABLE 4

| | 2nd UNDERCOAT LAYER | | | | | | | | | | | | | | |
|---|---|---|---|---|---|---|---|---|---|---|---|---|---|---|---|
| | | | | | | FILM | LATTICE | COER- | | | | | | | |
| | ALLOY COMPOSITION | | | | | THICK- | CON- | CIVE | ANGU- | | | | | | |
| | Cr | V | Cr + V | Mo | Nb | NESS | STANT | FORCE | LARITY | | | TAA | OW | PW50 | SNR |
| | at % | | | | | nm | Å | Oe | RATIO | HcOR | MrtOR | μV | dB | ns | dB |
| EXAMPLE 76 | 30 | 10 | 40 | 10 | 50 | 3 | 3.13 | 4218 | 0.827 | 1.11 | 1.69 | 1303 | 39.5 | 8.00 | 20.2 |
| EXAMPLE 77 | 10 | 0 | 10 | 80 | 10 | 3 | 3.14 | 4307 | 0.817 | 1.12 | 1.69 | 1312 | 38.2 | 8.10 | 20.4 |
| EXAMPLE 78 | 10 | 10 | 20 | 60 | 20 | 3 | 3.14 | 4281 | 0.820 | 1.12 | 1.71 | 1298 | 37.5 | 8.05 | 20.7 |
| EXAMPLE 79 | 20 | 0 | 20 | 50 | 30 | 3 | 3.14 | 4195 | 0.815 | 1.10 | 1.70 | 1341 | 39.5 | 8.09 | 20.4 |
| EXAMPLE 80 | 10 | 20 | 30 | 40 | 30 | 3 | 3.14 | 4267 | 0.817 | 1.12 | 1.68 | 1340 | 38.8 | 8.14 | 20.3 |
| EXAMPLE 81 | 20 | 10 | 30 | 30 | 40 | 3 | 3.14 | 4203 | 0.819 | 1.12 | 1.71 | 1356 | 38.4 | 8.01 | 20.8 |
| EXAMPLE 82 | 10 | 30 | 40 | 20 | 40 | 3 | 3.14 | 4152 | 0.816 | 1.11 | 1.68 | 1274 | 39.5 | 8.06 | 20.2 |
| EXAMPLE 83 | 30 | 0 | 30 | 20 | 50 | 3 | 3.14 | 4115 | 0.820 | 1.12 | 1.71 | 1309 | 39.0 | 8.04 | 20.4 |
| EXAMPLE 84 | 20 | 20 | 40 | 10 | 50 | 3 | 3.15 | 4241 | 0.824 | 1.11 | 1.69 | 1300 | 39.0 | 8.08 | 20.2 |
| EXAMPLE 85 | 10 | 0 | 10 | 70 | 20 | 3 | 3.15 | 4277 | 0.814 | 1.10 | 1.70 | 1295 | 38.7 | 8.08 | 20.2 |
| EXAMPLE 86 | 10 | 10 | 20 | 50 | 30 | 3 | 3.16 | 4258 | 0.818 | 1.12 | 1.71 | 1359 | 38.6 | 8.13 | 20.3 |
| EXAMPLE 87 | 20 | 0 | 20 | 40 | 40 | 3 | 3.16 | 4126 | 0.817 | 1.12 | 1.68 | 1345 | 40.0 | 8.03 | 20.7 |
| EXAMPLE 88 | 10 | 20 | 30 | 30 | 40 | 3 | 3.16 | 4265 | 0.822 | 1.11 | 1.72 | 1295 | 39.0 | 8.05 | 20.0 |
| EXAMPLE 89 | 20 | 10 | 30 | 20 | 50 | 3 | 3.16 | 4147 | 0.812 | 1.11 | 1.71 | 1339 | 40.1 | 8.08 | 20.3 |
| EXAMPLE 90 | 10 | 30 | 40 | 10 | 50 | 3 | 3.16 | 4176 | 0.821 | 1.10 | 1.69 | 1279 | 40.0 | 8.10 | 20.4 |
| EXAMPLE 91 | 30 | 0 | 30 | 10 | 60 | 3 | 3.16 | 4103 | 0.818 | 1.12 | 1.70 | 1285 | 39.1 | 8.07 | 20.1 |
| EXAMPLE 92 | 10 | 0 | 10 | 60 | 30 | 3 | 3.17 | 4237 | 0.811 | 1.12 | 1.69 | 1322 | 38.3 | 8.12 | 20.2 |
| EXAMPLE 93 | 10 | 10 | 20 | 40 | 40 | 3 | 3.17 | 4217 | 0.815 | 1.12 | 1.72 | 1378 | 39.6 | 8.04 | 20.6 |
| EXAMPLE 94 | 20 | 0 | 20 | 30 | 50 | 3 | 3.17 | 4099 | 0.813 | 1.10 | 1.71 | 1297 | 39.2 | 8.20 | 20.4 |
| EXAMPLE 95 | 10 | 20 | 30 | 20 | 50 | 3 | 3.17 | 4239 | 0.819 | 1.11 | 1.73 | 1342 | 38.5 | 7.98 | 20.0 |
| EXAMPLE 96 | 20 | 10 | 30 | 10 | 60 | 3 | 3.17 | 4150 | 0.819 | 1.11 | 1.68 | 1291 | 38.9 | 8.26 | 19.2 |
| EXAMPLE 97 | 10 | 0 | 10 | 50 | 40 | 3 | 3.18 | 4174 | 0.808 | 1.12 | 1.72 | 1320 | 39.5 | 8.14 | 19.5 |
| EXAMPLE 98 | 10 | 10 | 20 | 30 | 50 | 3 | 3.19 | 4173 | 0.812 | 1.12 | 1.71 | 1350 | 38.4 | 8.05 | 20.3 |
| EXAMPLE 99 | 20 | 0 | 20 | 20 | 60 | 3 | 3.19 | 4069 | 0.815 | 1.11 | 1.68 | 1300 | 40.9 | 8.16 | 20.3 |

TABLE 5

| | 2nd UNDERCOAT LAYER | | | | | | | | |
|---|---|---|---|---|---|---|---|---|---|
| | | | | | | | FILM | LATTICE | COERCIVE |
| | ALLOY COMPOSITION | | | | | | THICKNESS | CONSTANT | FORCE |
| | at % | | | | | | nm | Å | Oe |
| | Cr | V | Cr + V | Mo | Nb | | | | |
| EXAMPLE 101 | 10 | 0 | 10 | 40 | 50 | | 3 | 3.20 | 4118 |
| EXAMPLE 102 | 10 | 10 | 20 | 20 | 60 | | 3 | 3.20 | 4108 |
| EXAMPLE 103 | 20 | 0 | 20 | 10 | 70 | | 3 | 3.20 | 4110 |
| EXAMPLE 104 | 10 | 0 | 10 | 30 | 60 | | 3 | 3.21 | 4076 |
| EXAMPLE 105 | 10 | 10 | 20 | 10 | 70 | | 3 | 3.22 | 4105 |
| EXAMPLE 106 | 10 | 0 | 10 | 20 | 70 | | 3 | 3.23 | 4029 |
| EXAMPLE 107 | 30 | 10 | 40 | 30 | 30 | | 2 | 3.10 | 4125 |
| EXAMPLE 108 | 30 | 10 | 40 | 30 | 30 | | 5 | 3.10 | 4215 |
| | Cr | V | Cr + V | Mo | Nb | B | | | |
| EXAMPLE 109 | 28 | 10 | 38 | 30 | 30 | 2 | 3 | 3.10 | 4231 |
| EXAMPLE 110 | 25 | 10 | 35 | 30 | 30 | 5 | 3 | 3.10 | 4101 |
| | Cr | V | Cr + V | Mo | Ta | B | | | |
| EXAMPLE 111 | 30 | 10 | 40 | 30 | 30 | | 3 | 3.10 | 4312 |
| EXAMPLE 112 | 25 | 10 | 35 | 30 | 30 | 5 | 3 | 3.10 | 4134 |
| | Cr | V | Cr + V | Mo | Ti | B | | | |
| EXAMPLE 113 | 30 | 10 | 40 | 30 | 30 | | 3 | 3.10 | 4319 |
| EXAMPLE 114 | 25 | 10 | 35 | 30 | 30 | 5 | 3 | 3.10 | 4198 |
| | Cr | V | Cr + V | W | Nb | B | | | |
| EXAMPLE 115 | 30 | 10 | 40 | 30 | 30 | | 3 | 3.10 | 4317 |
| EXAMPLE 116 | 25 | 10 | 35 | 30 | 30 | 5 | 3 | 3.10 | 4177 |
| | Cr | V | Cr + V | W | Ta | B | | | |
| EXAMPLE 117 | 30 | 10 | 40 | 30 | 30 | | 3 | 3.10 | 4365 |
| EXAMPLE 118 | 25 | 10 | 35 | 30 | 30 | 5 | 3 | 3.10 | 4210 |
| | Cr | V | Cr + V | W | Ti | B | | | |
| EXAMPLE 119 | 30 | 10 | 40 | 30 | 30 | | 3 | 3.10 | 4355 |
| EXAMPLE 120 | 25 | 10 | 35 | 30 | 30 | 5 | 3 | 3.10 | 4134 |
| | Cr | V | Cr + V | Mo | Nb | | | | |
| COMPARATIVE | 30 | 10 | 40 | 30 | 30 | | 0.5 | 3.10 | 3439 |
| EXAMPLE 1 | | | | | | | | | |
| COMPARATIVE | 30 | 10 | 40 | 30 | 30 | | 12 | 3.10 | 4531 |
| EXAMPLE 2 | | | | | | | | | |

| | ANGULARITY | | | TAA | OW | PW50 | SNR |
|---|---|---|---|---|---|---|---|
| | RATIO | HcOR | MrtOR | μV | db | ns | db |
| EXAMPLE 101 | 0.812 | 1.09 | 1.73 | 1325 | 39.8 | 8.09 | 20.0 |
| EXAMPLE 102 | 0.806 | 1.09 | 1.69 | 1270 | 39.8 | 8.19 | 20.0 |
| EXAMPLE 103 | 0.805 | 1.10 | 1.70 | 1327 | 40.2 | 8.15 | 19.6 |
| EXAMPLE 104 | 0.812 | 1.08 | 1.70 | 1299 | 40.3 | 8.12 | 19.4 |
| EXAMPLE 105 | 0.812 | 1.08 | 1.72 | 1315 | 40.6 | 8.17 | 19.4 |
| EXAMPLE 106 | 0.804 | 1.08 | 1.73 | 1363 | 40.2 | 8.18 | 19.2 |
| EXAMPLE 107 | 0.804 | 1.08 | 1.73 | 1363 | 41.2 | 8.01 | 20.8 |
| EXAMPLE 108 | 0.831 | 1.07 | 1.71 | 1345 | 39.7 | 8.03 | 20.6 |
| EXAMPLE 109 | 0.814 | 1.12 | 1.71 | 1345 | 41.0 | 8.03 | 21.2 |
| EXAMPLE 110 | 0.802 | 1.11 | 1.72 | 1336 | 42.1 | 8.05 | 21.2 |
| EXAMPLE 111 | 0.824 | 1.10 | 1.69 | 1324 | 39.8 | 8.02 | 20.9 |
| EXAMPLE 112 | 0.814 | 1.11 | 1.70 | 1345 | 41.1 | 8.05 | 21.0 |
| EXAMPLE 113 | 0.821 | 1.12 | 1.71 | 1321 | 38.9 | 8.01 | 20.8 |
| EXAMPLE 114 | 0.811 | 1.10 | 1.70 | 1347 | 40.8 | 8.04 | 20.9 |
| EXAMPLE 115 | 0.823 | 1.11 | 1.71 | 1319 | 39.4 | 7.98 | 20.7 |
| EXAMPLE 116 | 0.809 | 1.11 | 1.70 | 1322 | 41.2 | 8.01 | 20.9 |
| EXAMPLE 117 | 0.824 | 1.10 | 1.72 | 1348 | 40.0 | 8.00 | 20.8 |
| EXAMPLE 118 | 0.817 | 1.12 | 1.71 | 1324 | 41.5 | 8.04 | 21.0 |
| EXAMPLE 119 | 0.829 | 1.11 | 1.70 | 1356 | 39.1 | 8.03 | 20.9 |
| EXAMPLE 120 | 0.821 | 1.11 | 1.69 | 1311 | 40.9 | 8.05 | 20.9 |
| COMPARATIVE | 0.679 | 1.05 | 1.48 | 1351 | 43.6 | 8.18 | 17.6 |
| EXAMPLE 1 | | | | | | | |
| COMPARATIVE | 0.855 | 1.08 | 1.70 | 1344 | 36.4 | 8.18 | 19.1 |
| EXAMPLE 2 | | | | | | | |

### COMPARATIVE EXAMPLES 1-2

Comparative Examples 1 and 2 were prepared using the same layer structure and the same alloy composition as those of Example 1 shown in Table 1, except for changing the thickness of the CrVMoNb second undercoat layer of the nonmagnetic undercoat layer of Example 1 as shown in Table 5, so as to have a different thickness, and magnetic recording mediums of Comparative Example 1 to 2 exhibit magnetic recording and reproduction properties as shown in Table 5.

### COMPARATIVE EXAMPLES 3-6

Comparative Examples 3 to 6 were prepared using the same layer structure and the same alloy composition as those of Example 1 shown in Table 1, except for replacing the second undercoat layer of the nonmagnetic undercoat layer of Example 1 with the second undercoat layer shown in Table 5, having the alloy composition changed from the Ru alloy to a CoCrTa alloy (Co: 70 at %, Cr: 28 at %, and Ta: 2 at %), and having different film thickness, and the magnetic recording medium of Comparative Examples 3 to 6 exhibits magnetic recording and reproduction properties as shown in Table 5.

TABLE 6

| | NONMAGNETIC UNDERCOAT LAYER | | | | NONMAGNETIC | | |
|---|---|---|---|---|---|---|---|
| | 1st UNDERCOAT LAYER | | 2nd UNDERCOAT LAYER | | INTERMEDIATE LAYER | | |
| | | FILM | | FILM | | FILM | COERCIVE |
| | ALLOY | THICKNESS | ALLOY | THICKNESS | ALLOY | THICKNESS | FORCE |
| | COMPOSITION | nm | COMPOSITION | nm | COMPOSITION | nm | Oe |
| COMPARATIVE | Cr | 2 | 80Cr—20Mo | 3 | Ru | 4 | 3571 |
| EXAMPLE 3 | | | | | | | |
| COMPARATIVE | Cr | 2 | 80Cr—20Mo—5B | 3 | Ru | 4 | 3467 |
| EXAMPLE 4 | | | | | | | |
| COMPARATIVE | Cr | 2 | 80Cr—20Mo | 3 | 70Co—28Cr—2Ta | 2 | 4105 |
| EXAMPLE 5 | | | | | | | |
| COMPARATIVE | Cr | 2 | 80Cr—20Mo—5B | 3 | 70Co—28Cr—2Ta | 2 | 4078 |
| EXAMPLE 6 | | | | | | | |

| | ANGULARITY | | | TAA | OW | PW50 | SNR |
|---|---|---|---|---|---|---|---|
| | RATIO | OR | MrtOR | (μV) | (dB) | (ns) | (dB) |
| COMPARATIVE | 0.692 | 1.04 | 1.31 | 1075 | 43.9 | 8.51 | 16.5 |
| EXAMPLE 3 | | | | | | | |
| COMPARATIVE | 0.654 | 1.03 | 1.29 | 1054 | 44.5 | 8.60 | 15.9 |
| EXAMPLE 4 | | | | | | | |
| COMPARATIVE | 0.776 | 1.07 | 1.60 | 1345 | 41.7 | 8.25 | 19.0 |
| EXAMPLE 5 | | | | | | | |
| COMPARATIVE | 0.752 | 1.08 | 1.57 | 1318 | 42.5 | 8.26 | 19.3 |
| EXAMPLE 6 | | | | | | | |

### EXAMPLE 121

A nonmagnetic substrate 1 was used, where an NiP film (thickness 12 μm) was formed by electroless deposition on the surface of an Al substrate (outside diameter 95 mm, inside diameter 25 mm, and thickness 1.270 mm), and the surface average roughness Ra was made to be 0.5 nm by performing texture processing on the surface thereof, was used. The nonmagnetic substrate 1 was accommodated in the chamber of a DC magnetron sputter device (Anerva Corp., C3010), and after the chamber was evacuated to a vacuum level of 2×1 Torr (2.7×10⁻⁵ Pa), the nonmagnetic substrate 1 was heated to 250° C. A nonmagnetic undercoat layer 2 was provided on this substrate. The nonmagnetic undercoat layer 2 was made to have a multilayer structure, with a second configuration layer (thickness 3 nm) comprising a CrVMoNb alloy (Cr: 30 at %, V: 10 at %, Mo: 30 at %, Nb: 30 at %) on a first configuration layer (thickness 2 nm) comprising Cr. Next, a stabilizing layer 7 (thickness 3 nm) comprising a CoCrPtTa alloy (Co: 67 at %, Cr: 20 at %, Pt: 10 at %, Ta: 3 at %) was formed. Next, a nonmagnetic coupling layer 8 (thickness 0.8 nm) comprising Ru was formed. Next, a magnetic layer 4 was provided. A first configuration layer (thickness 10 nm) comprising a CoCrPtB alloy (Co: 60 at %, Cr: 25 at %, Pt: 14 at %, B: 6 at %) was formed. Then, on top of this, a second configuration layer (thickness 10 nm) comprising a CoCrPtB alloy (Co: 60 at %, Cr: 10 at %, Pt: 15 at %, B: 15 at %) was formed. When forming each of the above-mentioned layers, Ar was used as the sputter gas, and the pressure thereof was made to be 6 mTorr (0.8 Pa). Next, a protective layer 5 (thickness 3 nm) comprising carbon was formed by CVD. Next, a lubricating layer 6 (thickness 2 nm) was formed by spreading a lubricant comprising perfluoropolyether on the surface of the protective layer 5, and the magnetic recording medium 11 was obtained.

### EXAMPLES 122-135

Examples 122 to 135 were prepared using the same layer structure and the same alloy composition as those of Example 1 shown in Table 1, except for replacing the second undercoat layer of CrVMoNb alloy of the nonmagnetic undercoat layer 2 of Example 1 with the second undercoat layer shown in Table 7 having different alloy compositions, and the magnetic recording medium of Example 122 to 135 exhibit magnetic recording and reproduction properties as shown in Table 5.

TABLE 7

| | 2nd UNDERCOAT LAYER | | | | | | | | STABILIZING LAYER | |
|---|---|---|---|---|---|---|---|---|---|---|
| | | | | | | | FILM | LATTICE | | FILM |
| | ALLOY COMPOSITION | | | | | | THICKNESS | CONSTANT | ALLOY | THICKNESS |
| | at % | | | | | | nm | Å | COMPOSITION | nm |
| | Cr | V | Cr + V | Mo | Nb | B | | | | |
| EXAMPLE 121 | 30 | 10 | 40 | 30 | 30 | | 3 | 3.10 | 67Co—20Cr—10Pt—3Ta | 3 |
| EXAMPLE 122 | 30 | 10 | 40 | 30 | 30 | | 2 | 3.10 | 67Co—20Cr—10Pt—3Ta | 3 |
| EXAMPLE 123 | 30 | 10 | 40 | 30 | 30 | | 5 | 3.10 | 67Co—20Cr—10Pt—3Ta | 3 |
| EXAMPLE 124 | 25 | 10 | 35 | 30 | 30 | 5 | 3 | 3.10 | 67Co—20Cr—10Pt—3Ta | 3 |
| | Cr | V | Cr + V | Mo | Ta | B | | | | |
| EXAMPLE 125 | 30 | 10 | 40 | 30 | 30 | | 3 | 3.10 | 67Co—20Cr—10Pt—3Ta | 3 |
| EXAMPLE 126 | 25 | 10 | 35 | 30 | 30 | 5 | 3 | 3.10 | 67Co—20Cr—10Pt—3Ta | 3 |
| | Cr | V | Cr + V | Mo | Ti | B | | | | |
| EXAMPLE 127 | 30 | 10 | 40 | 30 | 30 | | 3 | 3.10 | 67Co—20Cr—10Pt—3Ta | 3 |
| EXAMPLE 128 | 25 | 10 | 35 | 30 | 30 | 5 | 3 | 3.10 | 67Co—20Cr—10Pt—3Ta | 3 |
| | Cr | V | Cr + V | W | Nb | B | | | | |
| EXAMPLE 129 | 30 | 10 | 40 | 30 | 30 | | 3 | 3.10 | 67Co—20Cr—10Pt—3Ta | 3 |
| EXAMPLE 130 | 25 | 10 | 35 | 30 | 30 | 5 | 3 | 3.10 | 67Co—20Cr—10Pt—3Ta | 3 |
| | Cr | V | Cr + V | W | Ta | B | | | | |
| EXAMPLE 131 | 30 | 10 | 40 | 30 | 30 | | 3 | 3.10 | 67Co—20Cr—10Pt—3Ta | 3 |
| EXAMPLE 132 | 25 | 10 | 35 | 30 | 30 | 5 | 3 | 3.10 | 67Co—20Cr—10Pt—3Ta | 3 |
| | Cr | V | Cr + V | W | Ti | B | | | | |
| EXAMPLE 134 | 30 | 10 | 40 | 30 | 30 | | 3 | 3.10 | 67Co—20Cr—10Pt—3Ta | 3 |
| EXAMPLE 135 | 25 | 10 | 35 | 30 | 30 | 5 | 3 | 3.10 | 67Co—20Cr—10Pt—3Ta | 3 |

| | | | | | |
|---|---|---|---|---|---|
| COMPARATIVE | 80Cr—20Mo | 3 | 2.94 | 67Co—20Cr—10Pt—3Ta | 3 |
| EXAMPLE 7 | | | | | |
| COMPARATIVE | 80Cr—20Mo—5B | 3 | 2.94 | 67Co—20Cr—10Pt—3Ta | 3 |
| EXAMPLE 8 | | | | | |
| COMPARATIVE | 80Cr—20Mo | 3 | 2.94 | 77Co—20Cr—3Ta | 3 |
| EXAMPLE 9 | | | | | |
| COMPARATIVE | 80Cr—20Mo—5B | 3 | 2.94 | 77Co—20Cr—3Ta | 3 |
| EXAMPLE 10 | | | | | |

| | COERCIVE | | | | | | | |
|---|---|---|---|---|---|---|---|---|
| | FORCE | ANGULARITY | | | TAA | OW | PW50 | SNR |
| | Oe | RATIO | OR | MrtOR | (μV) | (dB) | (ns) | (dB) |
| EXAMPLE 121 | 4321 | 0.824 | 1.11 | 1.71 | 1289 | 39.5 | 7.89 | 21.3 |
| EXAMPLE 122 | 4219 | 0.819 | 1.10 | 1.70 | 1278 | 39.4 | 7.92 | 20.9 |
| EXAMPLE 123 | 4431 | 0.831 | 1.11 | 1.71 | 1299 | 38.6 | 7.87 | 21.0 |
| EXAMPLE 124 | 4278 | 0.819 | 1.10 | 1.69 | 1279 | 39.6 | 7.93 | 21.5 |
| EXAMPLE 125 | 4345 | 0.825 | 1.10 | 1.69 | 1277 | 38.6 | 7.88 | 21.1 |
| EXAMPLE 126 | 4244 | 0.815 | 1.11 | 1.70 | 1282 | 40.1 | 7.94 | 21.3 |
| EXAMPLE 127 | 4324 | 0.822 | 1.12 | 1.71 | 1266 | 39.0 | 7.91 | 20.9 |
| EXAMPLE 128 | 4289 | 0.813 | 1.11 | 1.70 | 1276 | 39.8 | 7.95 | 20.9 |
| EXAMPLE 129 | 4316 | 0.826 | 1.11 | 1.69 | 1285 | 38.5 | 7.87 | 20.8 |
| EXAMPLE 130 | 4212 | 0.813 | 1.11 | 1.69 | 1275 | 40.2 | 7.93 | 21.2 |
| EXAMPLE 131 | 4322 | 0.827 | 1.09 | 1.69 | 1284 | 38.5 | 7.87 | 20.6 |
| EXAMPLE 132 | 4242 | 0.811 | 1.11 | 1.71 | 1273 | 39.2 | 7.93 | 20.9 |
| EXAMPLE 134 | 4326 | 0.829 | 1.10 | 1.72 | 1287 | 38.6 | 7.85 | 20.4 |
| EXAMPLE 135 | 4211 | 0.816 | 1.10 | 1.70 | 1279 | 39.6 | 7.91 | 20.8 |
| COMPARATIVE | 3481 | 0.589 | 1.05 | 1.43 | 1059 | 42.5 | 8.71 | 16.1 |
| EXAMPLE 7 | | | | | | | | |
| COMPARATIVE | 3562 | 0.612 | 1.06 | 1.41 | 1049 | 43.6 | 8.84 | 15.9 |
| EXAMPLE 8 | | | | | | | | |
| COMPARATIVE | 4295 | 0.823 | 1.11 | 1.72 | 1298 | 38.6 | 8.21 | 19.3 |
| EXAMPLE 9 | | | | | | | | |
| COMPARATIVE | 4318 | 0.832 | 1.12 | 1.70 | 1276 | 39.1 | 8.25 | 19.5 |
| EXAMPLE 10 | | | | | | | | |

### COMPARATIVE EXAMPLES 7-8

Comparative Examples 7 and 8 were prepared using the same layer structure and the same alloy composition as those of Example 121 shown in Table 7, except for replacing the second undercoat layer of CrVMoNb alloy of the nonmagnetic undercoat layer 2 of Example 1 with the second undercoat layer shown in Table 7 having different alloy compositions and different lattice parameters, and the magnetic recording medium of Comparative Examples 7 and 8 exhibit magnetic recording and reproduction properties as shown in Table 7.

### COMPARATIVE EXAMPLES 9-10

Comparative Examples 9 and 10 were prepared using the same layer structure and the same alloy composition as those of Example 121 shown in Table 7, except for replacing the second undercoat layer of CrVMoNb alloy of the nonmagnetic undercoat layer 2 of Example 121 with the second undercoat layer shown in Table 7 having different alloy compositions and different lattice constants, and the magnetic recording medium of Comparative Examples 9 and 19 exhibit magnetic recording and reproduction properties as shown in Table 7.

### EXAMPLE 136

A nonmagnetic substrate 1, where texture processing was performed on a glass substrate (outside diameter 65 mm, inside diameter 20 mm, thickness 0.635 mm) to make the surface average roughness Ra 0.3 nm, was used. The nonmagnetic substrate 1 was accommodated in the chamber of a DC magnetron sputter device (Anerva Corp., C3010), and after the chamber was evacuated to a vacuum attainment level of 2×10⁻⁷ Torr (2.7×10⁻⁵ Pa), the nonmagnetic substrate 1 was heated to 250° C. After an orientation adjustment layer (thickness 5 nm) comprising a CoW alloy (Co: 50 at %, W: 50 at %) was formed on this substrate, this was heated to 250° C.

Next, the surface of the orientation adjustment layer was exposed to oxygen gas. The pressure of the oxygen gas was determined to be 0.05 Pa, and the process time was determined to be 5 seconds. The nonmagnetic undercoat layer 2 was provided on this substrate. The nonmagnetic undercoat layer 2 was made to have a multilayer structure, with a second undercoat layer (thickness 3 nm) comprising a CrVMoNb alloy (Cr: 10 at %, V: 30 at %, Mo: 30 at %, Nb: 30 at %) on a first configuration layer (thickness 2 nm) comprising Cr. Next a nonmagnetic intermediate layer 3 (thickness 4 nm) comprising Ru was formed. Next, a magnetic layer 4 was provided. A first magnetic layer (thickness 10 nm) comprising a CoCrPtB alloy (Co: 60 at %, Cr: 25 at %, Pt: 14 at %, B: 6 at %) was formed. Then, on top of the first magnetic layer, a second magnetic layer (thickness 10 nm) comprising a CoCrPtB alloy (Co: 60 at %, Cr: 10 at %, Pt: 15 at %, B: 15 at %) was formed.

When forming each of the above-mentioned layers, Ar was used as sputtering gas, and the pressure thereof was made to be 6 mTorr (0.8 Pa). Next, a protective layer 5 (thickness 3 nm) comprising carbon was formed by CVD. Next, a lubricating layer 6 (thickness 2 nm) was formed by spreading a lubricant comprising perfluoropolyether on the surface of the protective layer 5, and the magnetic recording medium 10 was obtained.

### EXAMPLES 137-149

Examples 137 to 149 were prepared using the same layer structure and the same alloy composition as those of Example 136 shown in Table 8, except for replacing the second undercoat layer of CrVMoNb alloy of the nonmagnetic undercoat layer of Example 136 with the second undercoat layer shown in Table 7 having different alloy compositions, and the magnetic recording medium of Comparative Examples 9 and 19 exhibit magnetic recording and reproduction properties as shown in Table 7.

TABLE 8

| | | | | | | | | | NONMAGNETIC | |
|---|---|---|---|---|---|---|---|---|---|---|
| | 2nd UNDERCOAT LAYER | | | | | | | | INTERMEDIATE LAYER | |
| | | | | | | | FILM | LATTICE | | FILM |
| | ALLOY COMPOSITION | | | | | | THICKNESS | COSTANT | ALLOY | THICKNESS |
| | at % | | | | | | nm | Å | COMPOSITION | nm |
| | Cr | V | Cr + V | Mo | Nb | B | | | | |
| EXAMPLE 136 | 30 | 10 | 40 | 30 | 30 | | 3 | 3.10 | Ru | 3 |
| EXAMPLE 137 | 30 | 10 | 40 | 30 | 30 | | 2 | 3.10 | Ru | 3 |
| EXAMPLE 138 | 30 | 10 | 40 | 30 | 30 | | 5 | 3.10 | Ru | 3 |
| EXAMPLE 139 | 25 | 10 | 35 | 30 | 30 | 5 | 3 | 3.10 | Ru | 3 |
| | Cr | V | Cr + V | Mo | Ta | B | | | Ru | |
| EXAMPLE 140 | 30 | 10 | 40 | 30 | 30 | | 3 | 3.10 | Ru | 3 |
| EXAMPLE 141 | 25 | 10 | 35 | 30 | 30 | 5 | 3 | 3.10 | Ru | 3 |
| | Cr | V | Cr + V | Mo | Ti | B | | | Ru | |
| EXAMPLE 142 | 30 | 10 | 40 | 30 | 30 | | 3 | 3.10 | Ru | 3 |
| EXAMPLE 143 | 25 | 10 | 35 | 30 | 30 | 5 | 3 | 3.10 | Ru | 3 |
| | Cr | V | Cr + V | W | Nb | B | | | Ru | |
| EXAMPLE 144 | 30 | 10 | 40 | 30 | 30 | | 3 | 3.10 | Ru | 3 |
| EXAMPLE 145 | 25 | 10 | 35 | 30 | 30 | 5 | 3 | 3.10 | Ru | 3 |
| | Cr | V | Cr + V | W | Ta | B | | | Ru | |
| EXAMPLE 146 | 30 | 10 | 40 | 30 | 30 | | 3 | 3.10 | Ru | 3 |
| EXAMPLE 147 | 25 | 10 | 35 | 30 | 30 | 5 | 3 | 3.10 | Ru | 3 |
| | Cr | V | Cr + V | W | Ti | B | | | Ru | |
| EXAMPLE 148 | 30 | 10 | 40 | 30 | 30 | | 3 | 3.10 | Ru | 3 |
| EXAMPLE 149 | 25 | 10 | 35 | 30 | 30 | 5 | 3 | 3.10 | Ru | 3 |

| | | | | | |
|---|---|---|---|---|---|
| COMPARATIVE | 80Cr—20Mo | 3 | 2.94 | Ru | 3 |
| EXAMPLE 11 | | | | | |
| COMPARATIVE | 80Cr—20Mo—5B | 3 | 2.94 | Ru | 3 |
| EXAMPLE 12 | | | | | |
| COMPARATIVE | 80Cr—20Mo | 3 | 2.94 | 77Co—20Cr—3Ta | 3 |
| EXAMPLE 13 | | | | | |
| COMPARATIVE | 80Cr—20Mo—5B | 3 | 2.94 | 77Co—20Cr—3Ta | 3 |
| EXAMPLE 14 | | | | | |

| | COERCIVE | | | | | | | |
|---|---|---|---|---|---|---|---|---|
| | FORCE | ANGULARITY | | | TAA | OW | PW50 | SNR |
| | Oe | RATIO | OR | MrtOR | (μV) | (dB) | (ns) | (dB) |
| EXAMPLE 136 | 4216 | 0.818 | 1.07 | 1.54 | 1245 | 40.2 | 8.15 | 19.8 |
| EXAMPLE 137 | 4138 | 0.809 | 1.06 | 1.45 | 1233 | 41.5 | 8.18 | 19.4 |
| EXAMPLE 138 | 4311 | 0.825 | 1.08 | 1.53 | 1251 | 39.1 | 8.14 | 19.6 |
| EXAMPLE 139 | 4176 | 0.806 | 1.06 | 1.51 | 1241 | 41.2 | 8.17 | 20.0 |
| EXAMPLE 140 | 4223 | 0.815 | 1.07 | 1.52 | 1245 | 40.2 | 8.21 | 19.6 |
| EXAMPLE 141 | 4121 | 0.802 | 1.06 | 1.49 | 1243 | 41.4 | 8.19 | 19.5 |
| EXAMPLE 142 | 4219 | 0.813 | 1.07 | 1.47 | 1253 | 40.9 | 8.20 | 19.4 |
| EXAMPLE 143 | 4176 | 0.805 | 1.08 | 1.47 | 1232 | 41.8 | 8.19 | 19.6 |
| EXAMPLE 144 | 4231 | 0.811 | 1.06 | 1.53 | 1233 | 40.2 | 8.18 | 19.2 |
| EXAMPLE 145 | 4167 | 0.802 | 1.08 | 1.46 | 1230 | 41.8 | 8.19 | 19.6 |
| EXAMPLE 146 | 4241 | 0.814 | 1.06 | 1.50 | 1255 | 40.8 | 8.18 | 19.5 |
| EXAMPLE 147 | 4149 | 0.805 | 1.07 | 1.47 | 1211 | 42.1 | 8.22 | 19.7 |
| EXAMPLE 148 | 4249 | 0.815 | 1.06 | 1.51 | 1229 | 40.7 | 8.20 | 19.3 |
| EXAMPLE 149 | 4140 | 0.803 | 1.08 | 1.47 | 1218 | 41.9 | 8.24 | 19.6 |
| COMPARATIVE | 3219 | 0.534 | 1.03 | 1.21 | 1011 | 44.5 | 8.99 | 14.8 |
| EXAMPLE 11 | | | | | | | | |
| COMPARATIVE | 3341 | 0.619 | 1.03 | 1.18 | 992 | 43.8 | 8.96 | 15.1 |
| EXAMPLE 12 | | | | | | | | |
| COMPARATIVE | 4210 | 0.812 | 1.07 | 1.45 | 1222 | 41.0 | 8.45 | 17.8 |
| EXAMPLE 13 | | | | | | | | |
| COMPARATIVE | 4198 | 0.802 | 1.06 | 1.48 | 1210 | 40.7 | 8.43 | 18.2 |
| EXAMPLE 14 | | | | | | | | |

### COMPARATIVE EXAMPLES 11-12

Comparative Examples 11 and 12 were prepared using the same layer structure and the same alloy composition as those of Example 136 shown in Table 8, except for replacing the second undercoat layer of CrVMoNb alloy of the nonmagnetic undercoat layer of Example 136 with the second undercoat layer shown in Table 8 having different alloy compositions and different lattice constant, and the magnetic recording medium of Comparative Examples 11 and 12 exhibit magnetic recording and reproduction properties as shown in Table 8.

### COMPARATIVE EXAMPLES 13-14

Comparative Examples 13 and 14 were prepared using the same layer structure and the same alloy composition as those of Example 136 shown in Table 8, except for replacing the second undercoat layer of CrVMoNb alloy of the nonmagnetic undercoat layer of Example 136 with the second undercoat layer shown in Table 8 having different alloy compositions and a different lattice constant, and the magnetic recording medium of Comparative Examples 11 and 12 exhibit magnetic recording and reproduction properties as shown in Table 8.

### EXAMPLE 150

A nonmagnetic substrate 1, where texture processing was performed on a glass substrate (outside diameter 65 mm, inside diameter 20 mm, thickness 0.635 mm) to make the surface average roughness Ra 0.3 mm, was used. The nonmagnetic substrate 1 was accommodated in the chamber of a DC magnetron sputter device (Anerva Corp., C3010), and after the chamber was evacuated to a vacuum attainment level of 2×1⁻⁷ Torr (2.7×10⁻⁵ Pa), the nonmagnetic substrate 1 was heated to 250° C. After an orientation adjustment layer (thickness 5 nm) comprising a CrTa alloy (Cr: 65 at %, Ta: 35 at %) was formed on this substrate, this was heated to 250° C. Next, the nonmagnetic undercoat layer 2 was provided on this substrate. The nonmagnetic undercoat layer 2 was made to have a multilayer structure, with a second undercoat layer (thickness 3 nm) comprising a CrVMoNb alloy (Cr: 10 at %, V: 30 at %, Mo: 30 at %, Nb: 30 at %) on a first undercoat layer (thickness 20 nm) comprising RuAl. Next a nonmagnetic intermediate layer 3 (thickness 4 nm) comprising Ru was formed. Next, a magnetic layer 4 was provided. A first magnetic layer (thickness 10 nm) comprising a CoCrPtB alloy (Co: 60 at %, Cr: 25 at %, Pt: 14 at %, B: 6 at %) was formed. Then, on top of this, a second magnetic layer (thickness 10 nm) comprising a CoCrPtB alloy (Co: 60 at %, Cr: 10 at %, Pt: 15 at %, B: 15 at %) was formed.

When forming each of the above-mentioned layers, Ar was used as the sputtering gas, and the pressure thereof was made to be 6 mTorr (0.8 Pa). Next, a protective layer 5 (thickness 3 nm) comprising carbon was formed by CVD. Next, a lubricating layer 6 (thickness 2 nm) was formed by spreading a lubricant comprising perfluoropolyether on the surface of the protective layer 5, and the magnetic recording medium 10 was obtained.

### EXAMPLES 151-163

Examples 151 to 163 were prepared using the same layer structure and the same alloy composition as those of Example 150 shown in Table 9, except for replacing the second undercoat layer of CrVMoNb alloy of the nonmagnetic undercoat layer of Example 136 with the second undercoat layer shown in Table 9 having different alloy compositions, and the magnetic recording medium of Examples 151 to 163 exhibit magnetic recording and reproduction properties as shown in Table 9.

TABLE 9

| | | | | | | | | | NONMAGNETIC | |
|---|---|---|---|---|---|---|---|---|---|---|
| | 2nd UNDERCOAT LAYER | | | | | | | | INTERMEDIATE LAYER | |
| | | | | | | | FILM | LATTICE | | FILM |
| | ALLOY COMPOSITION | | | | | | THICKNESS | CONSTANT | ALLOY | THICKNESS |
| | at % | | | | | | nm | Å | COMPOSITION | nm |
| | Cr | V | Cr + V | Mo | Nb | B | | | | |
| EXAMPLE 150 | 30 | 10 | 40 | 30 | 30 | | 3 | 3.10 | Ru | 3 |
| EXAMPLE 151 | 30 | 10 | 40 | 30 | 30 | | 2 | 3.10 | Ru | 3 |
| EXAMPLE 152 | 30 | 10 | 40 | 30 | 30 | | 5 | 3.10 | Ru | 3 |
| EXAMPLE 153 | 25 | 10 | 35 | 30 | 30 | 5 | 3 | 3.10 | Ru | 3 |
| | Cr | V | Cr + V | Mo | Ta | B | | | Ru | |
| EXAMPLE 154 | 30 | 10 | 40 | 30 | 30 | | 3 | 3.10 | Ru | 3 |
| EXAMPLE 155 | 25 | 10 | 35 | 30 | 30 | 5 | 3 | 3.10 | Ru | 3 |
| | Cr | V | Cr + V | Mo | Ti | B | | | Ru | |
| EXAMPLE 156 | 30 | 10 | 40 | 30 | 30 | | 3 | 3.10 | Ru | 3 |
| EXAMPLE 157 | 25 | 10 | 35 | 30 | 30 | 5 | 3 | 3.10 | Ru | 3 |
| | Cr | V | Cr + V | W | Nb | B | | | Ru | |
| EXAMPLE 158 | 30 | 10 | 40 | 30 | 30 | | 3 | 3.10 | Ru | 3 |
| EXAMPLE 159 | 25 | 10 | 35 | 30 | 30 | 5 | 3 | 3.10 | Ru | 3 |
| | Cr | V | Cr + V | W | Ta | B | | | Ru | |
| EXAMPLE 160 | 30 | 10 | 40 | 30 | 30 | | 3 | 3.10 | Ru | 3 |
| EXAMPLE 161 | 25 | 10 | 35 | 30 | 30 | 5 | 3 | 3.10 | Ru | 3 |
| | Cr | V | Cr + V | W | Ti | B | | | Ru | |
| EXAMPLE 162 | 30 | 10 | 40 | 30 | 30 | | 3 | 3.10 | Ru | 3 |
| EXAMPLE 163 | 25 | 10 | 35 | 30 | 30 | 5 | 3 | 3.10 | Ru | 3 |

| | | | | | |
|---|---|---|---|---|---|
| COMPARATIVE | 80Cr—20Mo | 3 | 2.94 | Ru | 3 |
| EXAMPLE 15 | | | | | |
| COMPARATIVE | 80Cr—20Mo—5B | 3 | 2.94 | Ru | 3 |
| EXAMPLE 16 | | | | | |
| COMPARATIVE | 80Cr—20Mo | 3 | 2.94 | 77Co—20Cr—3Ta | 3 |
| EXAMPLE 17 | | | | | |
| COMPARATIVE | 80Cr—20Mo—5B | 3 | 2.94 | 77Co—20Cr—3Ta | 3 |
| EXAMPLE 18 | | | | | |

| | COERCIVE | | | | | | | |
|---|---|---|---|---|---|---|---|---|
| | FORCE | ANGULARITY | | | TAA | OW | PW50 | SNR |
| | Oe | RATIO | OR | MrtOR | (μV) | (dB) | (ns) | (dB) |
| EXAMPLE 150 | 4219 | 0.807 | 1.07 | 1.46 | 1232 | 40.4 | 8.21 | 19.5 |
| EXAMPLE 151 | 4112 | 0.789 | 1.08 | 1.45 | 1243 | 41.8 | 8.22 | 19.3 |
| EXAMPLE 152 | 4289 | 0.812 | 1.07 | 1.46 | 1212 | 39.8 | 8.23 | 19.2 |
| EXAMPLE 153 | 4211 | 0.810 | 1.08 | 1.48 | 1242 | 39.7 | 8.21 | 19.5 |
| EXAMPLE 154 | 4213 | 0.809 | 1.07 | 1.48 | 1219 | 40.1 | 8.25 | 19.4 |
| EXAMPLE 155 | 4122 | 0.800 | 1.08 | 1.46 | 1217 | 41.9 | 8.27 | 19.5 |
| EXAMPLE 156 | 4287 | 0.809 | 1.07 | 1.45 | 1228 | 39.7 | 8.26 | 19.4 |
| EXAMPLE 157 | 4158 | 0.799 | 1.07 | 1.47 | 1236 | 40.2 | 8.21 | 19.6 |
| EXAMPLE 158 | 4278 | 0.799 | 1.06 | 1.46 | 1247 | 39.8 | 8.27 | 19.4 |
| EXAMPLE 159 | 4155 | 0.789 | 1.08 | 1.45 | 1219 | 40.4 | 8.29 | 19.6 |
| EXAMPLE 160 | 4212 | 0.811 | 1.06 | 1.49 | 1241 | 39.6 | 8.24 | 19.7 |
| EXAMPLE 161 | 4124 | 0.802 | 1.07 | 1.45 | 1252 | 40.1 | 8.26 | 19.4 |
| EXAMPLE 162 | 4234 | 0.811 | 1.06 | 1.42 | 1235 | 39.7 | 8.25 | 19.2 |
| EXAMPLE 163 | 4109 | 0.799 | 1.08 | 1.45 | 1246 | 40.1 | 8.24 | 19.6 |
| COMPARATIVE | 3677 | 0.567 | 1.02 | 1.19 | 1011 | 43.5 | 9.10 | 12.7 |
| EXAMPLE 15 | | | | | | | | |
| COMPARATIVE | 3190 | 0.673 | 1.03 | 1.15 | 991 | 45.4 | 8.98 | 13.9 |
| EXAMPLE 16 | | | | | | | | |
| COMPARATIVE | 4310 | 0.811 | 1.06 | 1.45 | 1241 | 38.9 | 8.51 | 16.7 |
| EXAMPLE 17 | | | | | | | | |
| COMPARATIVE | 4321 | 0.803 | 1.07 | 1.48 | 1214 | 39.8 | 8.53 | 17.8 |
| EXAMPLE 18 | | | | | | | | |

### COMPARATIVE EXAMPLES 15-16

Comparative Examples 15 to 16 were prepared using the same layer structure and the same alloy composition as those of Example 150 shown in Table 9, except for replacing the second undercoat layer of CrVMoNb alloy of the nonmagnetic undercoat layer of Example 136 with the second undercoat layer shown in Table 9 having different alloy compositions and a different lattice constant, and the magnetic recording medium of Comparative Examples 15 to 16 exhibit magnetic recording and reproduction properties as shown in Table 9.

### COMPARATIVE EXAMPLES 17-18

Comparative Examples 17 to 18 were prepared using the same layer structure and the same alloy composition as those of Example 150 shown in Table 9, except for replacing the second undercoat layer of CrVMoNb alloy of the nonmagnetic undercoat layer of Example 136 with the second undercoat layer shown in Table 9 having different alloy compositions and a different lattice constant, and the magnetic recording medium of Comparative Examples 17 to 18 exhibit magnetic recording and reproduction properties as shown in Table 9.

The results of lattice constant, coercive force (Hc), rectangularity ratio, magnetization orientation ratio (OR), magnetization orientation ratio (MrtOR) of the residual magnetization amount, and the electromagnetic transfer characteristics of Embodiments 1 to 149 and Comparative Examples 1 to 14 are shown in Tables 1 to 9. For measurement of the lattice constant, a 0-20 method of an X-ray measuring apparatus was executed, and respective lattice constants were obtained from the (200) peak position of the body-centered cubic crystal.

From Examples 1 to 108, it was observed that the magnetic recording mediums comprising second undercoat layers consisting of a CrVMoN alloy (including CrMoNb alloy and a VMoNb alloy) exhibit excellent magnetic and recording-reproducing characteristics compared to the comparative examples, providing that the lattice constant is within the range of 3.05 to 3.20, that the total content of Cr and V is 60 at % or more, and that the content of Nb of 60 at % or less. As shown in Tables 1 to 9, if the lattice constant is within the range of 3.05 Å to 3.20 Å, it was observed that the magnetic recording mediums exhibit excellent magnetic and recording-reproducing characteristics compared to the comparative example. Although there are some examples, in which the lattice constants are near 3.05, while characteristics are poor, it is noted that these samples have the total content of Cr and V of 60 at % or more, or have the content of Nb of 60 at % or more. From Tables 1 to 9, it can be seen that if the total content of Cr and V is 10 to 60 at %, the magnetic recording mediums exhibit excellent characteristics. Tables 1 to 9 also indicate that if the content of Mo is 10 to 80 at %, the magnetic recording mediums exhibit excellent characteristics. Tables 1 to 9 also indicates that if the content of Nb is 10 to 60 at %, this exhibits excellent characteristics. Although as shown in Tables 2, 3 and 4, there are examples which show the magnetic characteristics are poor even if the Nd content is in the abovementioned regions, these examples correspond to samples having the lattice constant of 3.05 or less or 3.20 or more, or to examples which contain the total content of Cr and V of 60 at % or more or the content of Nb of 60 at % or more. Comparative Example 1 in Table 5 showed that if the film thickness of the CrVMoNb alloy is thin indicating that the crystal growth is not sufficient, the coercive force reduces. Comparative Example 2 showed that if the film thickness of the CrVMoNb alloy is thin, the grain size is increased, which results in decreasing the SNR.

As shown in Examples 109 and 110, addition of B to the CrVMoNb alloy is effective in improving the SNR.

Examples 111 and 120 showed that the alloys other than CrVMoNb alloy, namely CrVMoTa alloy, CrVMoTi alloy, CrVWNb alloy, CrVWTa alloy, and CrVWTi alloy exhibit excellent characteristics can also be obtained. Moreover, similar effects are observed by the addition of B.

Comparative Examples 3 and 4 shown in Table 6 are examples, in which CrMo alloys and CrMoB alloys, which were generally used in magnetic recording mediums, have been used. However, the lattice constants of CrMo alloys and CrMoB alloys are small (80Cr-20Mo is 2.95 Å) compared to the CrMoVNb alloy and the like, and hence the Ru does not sufficiently epitaxially grow in the (110) direction. Therefore, as a result, the characteristics are considerably deteriorated. When a CrMo alloy and a CrMoB alloy are used, as shown in Comparative Examples 5 and 6, a CoCrTa alloy is generally used. However, even if the CoCrTa alloy is used, it was observed that compared to Examples, the SNR is inferior.

Examples 121 to 135 shown in table 7 are samples, in which CrVMoNb alloys, CrVMoTa alloys, CrVMoTi alloys, CrVWNb alloys, CrVWTa alloys, and CrVWTi alloys have been applied to ACF mediums. It can be seen that in all cases, they are superior to the comparative examples. Comparative Examples 7 and 8 are cases where CrMo alloys and CrMoB alloys, which are generally used in magnetic recording mediums, have been used. However the lattice constants of CrMo alloys and CrMoB alloys are small compared to the CrVMoNb alloys and the like, and hence the stabilizing layer of the CoCrPtTa alloy does not sufficiently epitaxially grow in the (110) direction. Therefore, as a result, the characteristics are considerably deteriorated. In a case where a CrMo alloy and CrMoB alloy are used, as shown in Comparative Examples 9 and 10, a CoCrTa alloy is generally used. However, even in this case, it can be seen that compared to the examples, the SNR is inferior.

Examples 136 to 149 shown in table 8 are cases where CrVMoNb alloys, CrVMoTa alloys, CrVMoTi alloys, CrVWNb alloys, CrVWTa alloys, and CrVWTi alloys have been applied to mediums which use a glass substrate for the nonmagnetic substrate 1. It can be seen that in all cases, they are superior to the comparative examples. Comparative Examples 11 and 12 are cases where CrMo alloys and CrMoB alloys, which are generally used in magnetic recording mediums, have been used. However the lattice constants of CrMo alloys and CrMoB alloys are small compared to the CrVMoNb alloys, and hence Ru does not sufficiently epitaxially grow in the (110) direction. Therefore, as a result, the characteristics are considerably deteriorated. In a case where a CrMo alloy and CrMoB alloy is used, as shown in Comparative Examples 13 and 14, a CoCrTa alloy is generally used. However, even in this case, it can be seen that compared to the examples, the SNR is inferior.

Examples 150 to 163 (refer to table 9) are cases where CrVMoNb alloys, CrVMoTa alloys, CrVMoTi alloys, CrVWNb alloys, CrVWTa alloys, or CrVWTi alloys were used and applied as the second undercoat layer on the RuAl film instead of the Cr film for covering the glass substrate as the nonmagnetic substrate. It was observed that in all cases, they are superior to the comparative examples. Comparative Examples 15 and 16 are cases where CrMo alloys and CrMoB alloys, which are generally used in the undercoat layer of the magnetic recording mediums, have been used. However the lattice constants of CrMo alloys and CrMoB alloys are small compared to the CrVMoNb alloys and the like, and hence the Ru does not sufficiently epitaxially grow in the (110) direction. Therefore, as a result, the magnetic and recording and reproducing characteristics are considerably deteriorated. In a case where a CrMo alloy and CrMoB alloy is used, as shown in Comparative Examples 17 and 18, a CoCrTa alloy is generally used. However, even in this case, it can be seen that compared to the examples, the SNR is inferior.

### INDUSTRIAL APPLICABILITY

Because the magnetic recording medium of the present invention comprises at least a nonmagnetic undercoat layer, a nonmagnetic intermediate layer (a stabilizing layer or a nonmagnetic coupling layer may be utilized instead of a nonmagnetic intermediate layer), a magnetic layer, and a protective layer laminated in this order on a nonmagnetic substrate, wherein since at least one of the layers of the nonmagnetic undercoat layer is constituted by a multicomponent body-centered cubic crystal alloy, a magnetic noise can be reduced. Magnetic recording mediums obtained in the prevent invention are suitable for high recording density.

1. A magnetic recording medium comprising at least a nonmagnetic undercoat layer, a nonmagnetic intermediate layer, a magnetic layer, and a protective layer, laminated in the ascending order on a nonmagnetic substrate,
wherein at least one layer of said nonmagnetic undercoat layer is configured by a multicomponent body-centered cubic crystal alloy, which comprises at least one element selected from the A group consisting of Cr and V, at least one element selected from the B group consisting of Mo and W, and at least one element selected from the C group consisting of Nb, Ta, and Ti.

2. A magnetic recording medium having at least a nonmagnetic undercoat layer, a stabilizing layer, a nonmagnetic intermediate layer, a nonmagnetic coupling layer, a magnetic layer, and a protective layer, laminated in the ascending order on a nonmagnetic substrate, and said stabilizing layer is antiferromagnetically coupled to said magnetic layer,
wherein at least one layer of said nonmagnetic undercoat layer is constituted by a multicomponent body-centered cubic crystal alloy comprising at least one element selected from the following A group consisting of Cr and V, at least one element selected from the B group consisting of Mo and W, and at least one element selected from the C group consisting of Nb, Ta, and Ti.

3. The magnetic recording medium according to either one of claim 1 and claim 2, wherein in the multicomponent body-centered cubic crystal alloy used in said nonmagnetic undercoat layer, the element selected from the A group has a total content of 10 to 60 at %, the element selected from the B group has a total content of 10 to 80 at %, and the element selected from the C group has a total content of 10 to 60 at %.

4. The magnetic recording medium according to either one of claim 1 and claim 2, wherein the multicomponent body-centered cubic crystal alloy used in said nonmagnetic undercoat layer has a body-centered cubic structure, and the lattice constant is from 3.05 to 3.20 Å.

5. The magnetic recording medium according to either one of claim 1 and claim 2, wherein said nonmagnetic intermediate layer comprises at least one elemental metal or alloy selected from the group consisting of CoCr alloys, CoCrPt alloys, Ru, a Ru alloys, Re, and Re alloys.

6. The magnetic recording medium according to either one of claim 1 and claim 2, wherein said nonmagnetic coupling layer comprises at least one elemental metal or alloy selected from the group consisting of Ru, Rh, Ir, Cr, Re, Ru alloys, Rh alloys, Ir alloys, Cr alloys, and Re alloys, and said nonmagnetic coupling layer has a thickness of 0.5 to 1.5 nm.

7. The magnetic recording medium according to either one of claim 1 and claim 2, wherein said nonmagnetic intermediate layer comprises at least one alloy selected from the group consisting of CoCrZr alloys, CoCrTa alloys, CoRu alloys, CoCrRu alloys, CoCrPtZr alloys, CoCrPtTa alloys, a CoPtRu alloys, and CoCrPtRu type alloys.

8. The magnetic recording medium according to either one of claim 1 and claim 2, wherein said nonmagnetic undercoat layer has a multilayer structure including a layer comprising Cr or a Cr alloy comprising Cr and at least one element selected from the group consisting of Ti, Mo, Al, Ta, W, Ni, B, Si, Mn and V, and a layer comprising a multicomponent body-centered cubic crystal alloy.

9. The magnetic recording medium according to either one of claim 1 and claim 2, wherein said nonmagnetic undercoat layer has a multilayer structure containing a layer comprising NiAl alloys, RuAl alloys, and a multicomponent body-centered cubic crystal alloy.

10. The magnetic recording medium according to either one of claim 1 and claim 2, wherein said magnetic layer comprises at least one alloy selected from the group consisting of CoCrTa alloys, CoCrPtTa alloys, CoCrPtB alloys, and CoCrPtBM (where M is one or more elements selected from Ta, Cu, and Ag) alloys.

11. The magnetic recording medium according to either one of claim 1 and claim 2, wherein said nonmagnetic substrate is a glass substrate or a silicon substrate.

12. The magnetic recording medium according to either one of claim 1 and claim 2, wherein said nonmagnetic substrate is a substrate where a film comprising NiP or a NiP alloy is formed on the surface of a substrate selected from the group of Al, Al alloy, glass, and silicon.

13. A method of producing a magnetic recording medium having at least a nonmagnetic undercoat layer, a nonmagnetic intermediate layer, a magnetic layer, and a protective layer laminated in this order on a nonmagnetic substrate, wherein at least one layer of said nonmagnetic undercoat layer is constituted by a multicomponent body-centered cubic crystal alloy.

14. A method of producing a magnetic recording medium having at least a nonmagnetic undercoat layer, a stabilizing layer, a nonmagnetic coupling layer, a magnetic layer, and a protective layer laminated in the ascending order on a nonmagnetic substrate, wherein said stabilizing layer is antiferromagnetically bonded to said magnetic layer, and at least one layer of said nonmagnetic undercoat layer is constituted by a multicomponent body-centered cubic crystal alloy.

15. A magnetic recording and reproducing apparatus comprising a magnetic recording medium according to either one of claim 1 and claim 2, and a magnetic head which records and reproduces information on said magnetic recording medium.
